(19) United States
(12) Patent Application Publication
(10) Pub. No.: US 2020/0398484 A1
(43) Pub. Date: Dec. 24, 2020

(54) THREE-DIMENSIONAL PRINTING

(71) Applicant: HEWLETT-PACKARD DEVELOPMENT COMPANY, L.P., SPRING, TX (US)

(72) Inventors: JESISKA TANDY, SAN DIEGO, CA (US); YI FENG, SAN DIEGO, CA (US); ANDRE GARCIA, SAN DIEGO, CA (US)

(21) Appl. No.: 16/962,746

(22) PCT Filed: Mar. 9, 2018
(86) PCT No.: PCT/US2018/021808

§ 371 Date: Jul. 16, 2020

(51) Int. Cl. B29C 64/188; B29C 64/264; B29C 64/165

(52) U.S. Cl. CPC B29C 64/188; B33Y 10/00; B29C 64/165; B29C 64/264

(57) ABSTRACT

An example of a method for three-dimensional (3D) printing includes applying a build material composition to form a build material layer. The build material composition includes a glass core coated with a polyamide material. Based on a 3D object model, a fusing agent is selectively applied on a portion of the build material composition, and a detailing agent is selectively applied on another portion of the build material composition. The build material composition is exposed to radiation to fuse the portion to form a layer of a 3D part.

### BACKGROUND

Three-dimensional (3D) printing may be an additive printing process used to make three-dimensional solid parts from a digital model. 3D printing is often used in rapid product prototyping, mold generation, mold master generation, and short run manufacturing. Some 3D printing techniques are considered additive processes because they involve the application of successive layers of material (which, in some examples, may include build material, binder and/or other printing liquid(s), or combinations thereof). This is unlike traditional machining processes, which often rely upon the removal of material to create the final part. Some 3D printing methods use chemical binders or adhesives to bind build materials together. Other 3D printing methods involve at least partial curing, thermal merging/fusing, melting, sintering, etc. of the build material, and the mechanism for material coalescence may depend upon the type of build material used. For some materials, at least partial melting may be accomplished using heat-assisted extrusion, and for some other materials (e.g., polymerizable materials), curing or fusing may be accomplished using, for example, ultra-violet light or infrared light.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating an example of a method for 3D printing;

FIG. 2 is a flow diagram illustrating another example of a method for 3D printing;

FIG. 3 is a flow diagram illustrating yet another example of a method for 3D printing;

FIGS. 4A through 4E are schematic and partially cross-sectional cutaway views depicting the formation of a 3D part using an example of the 3D printing method disclosed herein;

FIG. 5 is a top, schematic view of the build material with a fusing agent applied on a portion thereof, a coloring agent applied on at least some of the portion thereof, and a detailing agent applied another portion thereof; and

FIG. 6 is a simplified isometric and schematic view of an example of a 3D printing system disclosed herein.

### DETAILED DESCRIPTION

Some examples of three-dimensional (3D) printing may utilize a fusing agent (including a radiation absorber) to pattern polymeric build material. In these examples, an entire layer of the polymeric build material is exposed to radiation, but the patterned region (which, in some instances, is less than the entire layer) of the polymeric build material is fused/coalesced and hardened to become a layer of a 3D part. In the patterned region, the fusing agent is capable of at least partially penetrating into voids between the polymeric build material particles, and is also capable of spreading onto the exterior surface of the polymeric build material particles. This fusing agent is capable of absorbing radiation and converting the absorbed radiation to thermal energy, which in turn fuses/coalesces the polymeric build material that is in contact with the fusing agent. Fusing/coalescing causes the polymeric build material to join or blend to form a single entity (i.e., the layer of the 3D part). Fusing/coalescing may involve at least partial thermal merging, melting, binding, and/or some other mechanism that coalesces the polymeric build material to form the layer of the 3D part.

Build material for 3D printing may include fillers to modify the properties of the 3D parts to be formed therefrom and/or to reduce the cost of the build material. For example, a build material composition including a polymeric build material and a glass filler may be used to print 3D parts with high stiffness and/or with a high heat deflection temperature or heat distortion temperature. The properties of the different filler and build materials and/or the interaction of the different materials with the 3D printing system components may result in the separation of the materials during printing. Material separation during printing can deleteriously affect the compositional uniformity, the mechanical properties, and/or the aesthetics of the final 3D part. As one example, mixed glass filler and polyamide build material may have different densities, which can result in separation of the materials during printing. As another example, mixed glass filler and polyamide build material may interact differently with the build material distributor of a 3D printing system, which may result in the partial segregation of the glass and the polyamide during spreading.

### Build Material Compositions

Disclosed herein is a build material composition that includes a coated material. The coated material includes a glass core coated with a polyamide material. In some examples, the build material composition consists of the glass core coated with the polyamide material. In other examples, the build material composition may include the coated material and additional components, such as a filler, an antioxidant, a brightener, a charging agent, a flow aid, or a combination thereof.

In the examples disclosed herein, coating the glass core with the polyamide material prevents the glass core from separating from the polyamide material, for example, during the printing process. In addition to preventing separation, the coated material disclosed herein may also lead to 3D parts with more uniform composition, mechanical properties, and aesthetics. Moreover, examples of the coated material disclosed herein that remain non-fused after printing may be reused successfully in subsequent printing processes (i.e., the coated build material composition is recyclable).

As mentioned above, the coated material includes the glass core coated with the polyamide material. The polyamide material may form a continuous coating (i.e., none of the glass core is exposed) or a substantially continuous coating (i.e., 5% or less of the glass core is exposed) on the glass core.

In some examples, the polyamide material is selected from the group consisting of polyamide 12 (PA 12/nylon 12), polyamide 11 (PA 11/nylon 11), polyamide 6 (PA 6/nylon 6), polyamide 13 (PA 13/nylon 13), and a combination thereof. In other examples, the polyamide material is selected from the group consisting of polyamide 11, polyamide 6, polyamide 13, and a combination thereof.

In some examples, the polyamide material may have a reactivity less than or equal to 5%. In one of these examples, the polyamide material may have a reactivity ranging from 0% to 5%. In another one of these examples, the polyamide material may have a reactivity ranging from −5% to 5%. Using a polyamide material with a reactivity less than or equal to 5% may improve the recyclability/reusability of the build material composition (as compared to a similar build material composition, except that the similar build material composition includes a polyamide material with a higher reactivity).

As used herein, the term “reactivity” refers to a material's propensity to change over time (e.g., a change in molecular weight, (weight average or number average) and/or a change in relative solution viscosity). As such, reactivity may be represented as a percentage (i.e., the value of the change (the value after a time period minus the original value) divided by the original value, multiplied by 100).

Reactivity may be measured in terms of the change in molecular weight or the change in relative solution viscosity. The molecular weight of the polyamide material can be characterized using relative solution viscosity (or “solution viscosity” or “relative viscosity” for brevity) as a proxy for molecular weight. Solution viscosity is determined by combining 0.5 wt % of the polyamide material with 99.5 wt % of m-cresol (also known as 3-methylphenol) and measuring the viscosity of the mixture at room temperature (e.g., 20° C.) compared to the viscosity of pure m-cresol. The viscosity measurements are based on the time it takes for a certain volume of the mixture or liquid to pass through a capillary viscometer under its own weight or gravity. The solution viscosity is defined as a ratio of the time it takes the mixture (including the polyamide material) to pass through the capillary viscometer to the time it takes the pure liquid takes to pass through the capillary viscometer. As the mixture is more viscous than the pure liquid and a higher viscosity increases the time it takes to pass through the capillary viscometer, the solution viscosity is greater than 1. As an example, the mixture of 0.5 wt % of the polyamide material in 99.5 wt % of the m-cresol may take about 180 seconds to pass through the capillary viscometer, and m-cresol may take about 120 seconds to pass through the capillary viscometer. In this example, the solution viscosity is 1.5 (i.e., 180 seconds divided by 120 seconds). Further details for determining solution viscosity under this measurement protocol are described in International Standard ISO 307, Fifth Edition, 2007-05-15, incorporated herein by reference in its entirety.

To facilitate the measurement of the change in solution viscosity, the polyamide material may be subjected to an aging process for a predetermined amount of time at a specific temperature profile. For example, the aging process may include exposing the polyamide material to an air environment that has a temperature of about 165° C. for about 20 hours. The air environment of this example aging process may be similar to or slightly harsher than the environment to which the polyamide material may be exposed during 3D printing. The 165° C. temperature of this example aging process may be similar to the temperature(s) to which the polyamide material may be exposed during 3D printing (e.g., a feed build material temperature ranging from about 120° C. to about 140° C., a platform heater temperature ranging from about 145° C. to about 160° C., a build material temperature from heating lamps during printing ranging from about 155° C. to about 165° C., etc.). Moreover, the 20 hour time period of this example aging process may be similar to the time period and/or may be representative of several thermal cycles of the 3D printing process. In other examples, the aging time may be extended to compensate for a printing process temperature that is higher than the aging temperature. As such, the conditions associated with the aging process may, without melting the polyamide material, facilitate the change in molecular weight (and therefore, the change in relative solution viscosity) that the polyamide material may have exhibited as a result of being exposed to 3D printing. It is to be understood that the change that the polyamide material may have exhibited as a result of being exposed to 3D printing may be less than the change resulting from the aging process facilitates depending, in part, on the environment, the temperature, and the time period of the 3D printing process. It is also to be understood that other aging processes may be used (e.g., with a temperature up to 220° C., as long as the temperature used is below the melting temperature of the polyamide material used). It is to be further understood, however, that, as used herein, any reactivity, any change in molecular weight, and any change in relative solution viscosity is in relation to the example aging process described herein (i.e., exposing the polyamide material to an air environment and a temperature of about 165° C. for about 20 hours).

The change in solution viscosity (which correlates to the change in molecular weight) may be determined by measuring the solution viscosity of the polyamide material before and after the aging process, and subtracting the “before” solution viscosity from the “after” solution viscosity. Typically, the solution viscosity of the polyamide material is greater after the aging process than before the aging process due, in part, to polymerization through reactive end groups of the polyamide material (i.e., due to the reactivity of the polyamide material). However, thermal degradation (through oxidation) of the polyamide material may mitigate the increase. As examples, the polyamide material may have a solution viscosity or a relative viscosity ranging from about 1.5 to about 1.9 or from about 1.7 to about 1.9 before the aging process. After the aging process, the solution viscosity or relative viscosity of the polyamide material may increase or decrease by 5% or less. As such, the reactivity of the polyamide material is less than or equal to 5%. In these examples, the reactivity of the polyamide material may also be within the range of −5% to 5%.

As mentioned above, a polyamide material with a reactivity less than or equal to 5% may be more suitable for being reused/recycled than higher reactivity polyamides. As such, in the examples disclosed herein, the glass core coated with the low reactivity polyamide may also be reused/recycled. After a print cycle, some of the build material composition disclosed herein remains non-fused, and can be reclaimed and used again. This reclaimed build material is referred to as the recycled build material composition. The recycled build material composition may be exposed to 2, 4, 6, 8, 10, or more build cycles (i.e., heating to a temperature ranging from about 5° C. to about 50° C. below the melting point or softening point of the polyamide material, and then cooling), and reclaimed after each cycle. Between cycles, the recycled build material composition may be mixed with at least some fresh or virgin (i.e., not previously used in a 3D printing process) build material composition. In some examples, the weight ratio of the recycled build material composition to the fresh build material composition may be 90:10, 80:20, or 70:30. In other examples, about 20 wt % of fresh build material composition may be mixed with the recycled build material composition.

In some examples, the polyamide material is polyamide 12. In these examples, the polyamide 12 may include greater than 80 meq/g carboxylic end groups and less than 40 meq/g amino end groups. The upper limit of the amount of carboxylic end groups may be related to a capacity of end group locations. In some examples, the polyamide 12 may include greater than 90 meq/g carboxylic end groups; or from greater than 80 meq/g to 200 meq/g carboxylic end groups; or from 90 meq/g to 200 meq/g carboxylic end groups; or from greater than 80 meq/g to 170 meq/g carboxylic end groups; or from 90 meq/g to 170 meq/g carboxylic end groups. In other examples, the polyamide 12 may include less than 30 meq/g amino end groups; or from 2 meq/g to less than 40 meq/g amino end groups; or from 5 meq/g to less than 30 meq/g amino end groups. The end group values of the polyamide 12 may be determined by titration. It may be difficult to determine the amount of amino end groups when the polyamide 12 includes less than 2 meq/g amino end groups. As such, when the polyamide 12 includes less than 2 meq/g amino end groups, the polyamide 12 may be considered to include essentially no amino end groups.

Any of the polyamide materials disclosed herein may have a wide processing window of greater than 5° C. (i.e., the temperature range between the melting point and the re-crystallization temperature). As examples, the polyamide material may have a melting point or softening point ranging from about 160° C. to about 200° C., from about 170° C. to about 190° C., or from about 182° C. to about 189° C. As another example, the polyamide material may have a melting point of about 180° C.

The build material composition also includes the glass core. In an example, the glass core is essentially spherical. In another example, the glass core has an asymmetrical aspect ratio ranging from greater than 1:1 to about 2:1 (i.e., longest to shortest axis by length).

In an example, the glass core is selected from the group consisting of solid glass beads, hollow glass beads, porous glass beads, glass fibers, crushed glass, and a combination thereof. In another example, the glass core is selected from the group consisting of soda lime glass (Na₂O/CaO/SiO₂), borosilicate glass, phosphate glass, fused quartz, and a combination thereof. In still another example, the glass core is selected from the group consisting of soda lime glass, borosilicate glass, and a combination thereof. In yet other examples, the glass core may be any type of non-crystalline silicate glass.

In some examples, a surface of the glass core is modified with a functional group selected from the group consisting of an acrylate functional silane, a methacrylate functional silane, an epoxy functional silane, an ester functional silane, an amino functional silane, and a combination thereof. Examples of the glass core modified with such functional groups and/or such functional groups that may be used to modify the glass are available from Potters Industries, LLC (e.g., an epoxy functional silane or an amino functional silane), Gelest, Inc. (e.g., an acrylate functional silane or a methacrylate functional silane), Sigma-Aldrich (e.g., an ester functional silane), etc. In an example, the surface of the glass core is modified with an amino functional silane. In another example, the surface of the glass core is modified with an epoxy functional silane. In other examples, a surface of the glass is not modified with any functional group.

In some examples, the coated material (i.e., the glass core coated with the polyamide material) may be translucent or transparent. As used herein, “translucent” or “transparent,” means that 80% or more of visible light (i.e., light with a wavelength ranging from 380 nm to 700 nm) can be transmitted through the coated material. In other examples, the coated material may be opaque. As used herein, “opaque” means that more than 20% of visible light (i.e., light with a wavelength ranging from 380 nm to 700 nm) is absorbed by or reflected off the coated material.

In some examples, the coated material may be colorless or white. As used herein, “colorless,” means that the coated material is achromatic and does not include a colorant. In other examples, a colorant may be added with the polyamide material. In these examples, the colorant may any of the colorants listed below in reference to the detailing agent, and may be included in the coated material in an amount ranging from about 0.05 wt % to about 4 wt % (based on the weight of the polyamide material).

The coated material may be made up of similarly sized particles or differently sized particles. In an example, the coated material may have an average aspect ratio of less than 2:1 (i.e., longest axis to shortest axis). In another example, the coated material may have an average aspect ratio of about 1:1.

The term “particle size”, as used herein, refers to the diameter of a spherical particle, or the average diameter of a non-spherical particle (i.e., the average of multiple diameters across the particle), or the volume-weighted mean diameter of a particle distribution. In some examples, the particle size may be determined using laser scattering (e.g., with a Malvern Mastersizer S, version 2.18). In an example, the average particle size of the coated material ranges from about 20 μm to about 200 μm. In another example, the average particle size of the coated material ranges from about 10 μm to about 100 μm. In other examples, the D50 value of the coated material (i.e., the median of the particle size distribution, where ½ the population is above this value and ½ is below this value) may range from about 30 μm to about 70 μm or from about 40 μm to about 60 μm, or may be about 50 μm. In still other examples, the D10 value of the coated material (i.e., 10% by weight of the population is below this value) may range from about 15 μm to about 45 μm or from about 20 μm to about 40 μm, or may be about 30 μm. In yet other examples, the D90 value of the coated material (i.e., 90% by weight of the population is below this value) may range from about 70 μm to about 90 μm or from about 75 μm to about 85 μm, or may be about 80 μm.

Before being coated with the polyamide material, the glass core may have an average particle size ranging from about 5 μm to about 100 μm. In an example, the uncoated glass core may have an average particle size ranging from about 10 μm to about 60 μm. In other examples, the D50 value of the uncoated glass core ranges from about 10 μm to about 50 μm or from about 25 μm to about 50 μm, or may be about 40 μm. In still other examples the D10 value of the uncoated glass core may range from about 10 μm to about 40 μm or from about 15 μm to about 35 μm, or may be about 25 μm. In yet other examples, the D90 value of the uncoated glass may range from about 30 μm to about70 μm or from about 40 μm to about 60 μm, or may be about 50 μm.

The weight ratio of the glass core to the polyamide material ranges from about 5:95 to about 60:40. In some examples, the weight ratio of the glass core to the polyamide material ranges from about 10:90 to about 60:40; or from about 20:80 to about 60:40; or from about 40:60 to about 60:40; or from about 5:95 to about 40:60; or from about 5:95 to about 50:50. In another example, the weight ratio of the glass core to the polyamide material is 40:60. In still another example, the weight ratio of the glass core to the polyamide material is 50:50. In yet another example, the weight ratio of the glass core to the polyamide material is 60:40. The weight ratio of the glass core to the polyamide material may depend, in part, on the desired properties of the 3D part to formed, the glass core used, and/or the polyamide material used.

In some examples, the build material composition further includes, in addition to the coated material, a filler selected from the group consisting of alumina, silica, glass, talc, and a combination thereof. The filler may be added to the build material composition to modify the properties of the 3D parts to be printed. In an example, the filler may be included in the build material composition in an amount ranging from about 1 wt % to about 60 wt %, based on the total weight of the build material composition.

In some examples, the build material composition, in addition to the glass core coated with the polyamide material (and, in some cases, the filler), may include an antioxidant, a brightener, a charging agent, a flow aid, or a combination thereof. While several examples of these additives are provided, it is to be understood that these additives are selected to be thermally stable (i.e., will not decompose) at the 3D printing temperatures.

Antioxidant(s) may be added to the build material composition to prevent or slow molecular weight decreases of the polyamide material and/or may prevent or slow discoloration (e.g., yellowing) of the polyamide material by preventing or slowing oxidation of the polyamide material. In some examples, the antioxidant may be a radical scavenger. In these examples, the antioxidant may include IRGANOX® 1098 (benzenepropanamide, N,N′-1,6-hexanediylbis(3,5-bis(1,1-dimethylethyl)-4-hydroxy)), IRGANOX® 254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). The antioxidant may be in the form of fine particles (e.g., having an average particle size of 5 μm or less) that are dry blended with the coated material. In an example, the antioxidant may be included in the build material composition in an amount ranging from about 0.01 wt % to about 5 wt %, based on the total weight of the build material composition. In other examples, the antioxidant may be included in the build material composition in an amount ranging from about 0.01 wt % to about 2 wt % or from about 0.2 wt % to about 1 wt %, based on the total weight of the build material composition.

Brightener(s) may be added to the build material composition to improve visibility. Examples of suitable brighteners include titanium dioxide (TiO₂), zinc oxide (ZnO), calcium carbonate (CaCO₃), zirconium dioxide (ZrO₂), aluminum oxide (Al₂O₃), silicon dioxide (SiO₂), and combinations thereof. In some examples, a stilbene derivative may be used as the brightener. In these examples, the temperature(s) of the 3D printing process may be selected so that the stilbene derivative remains stable (i.e., the 3D printing temperature does not thermally decompose the stilbene derivative). In an example, the brightener may be included in the build material composition in an amount ranging from greater than 0 wt % to about 10 wt %, based on the total weight of the build material composition.

Charging agent(s) may be added to the build material composition to suppress tribo-charging. Examples of suitable charging agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available charging agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.). In an example, the charging agent is added in an amount ranging from greater than 0 wt % to less than 5 wt %, based upon the total weight of the build material composition.

Flow aid(s) may be added to improve the coating flowability of the build material composition. Flow aids may be particularly beneficial when the build material composition has an average particle size less than 25 μm. The flow aid improves the flowability of the build material composition by reducing the friction, the lateral drag, and the tribocharge buildup (by increasing the particle conductivity). Examples of suitable flow aids include tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and aluminum oxide. In an example, the flow aid is added in an amount ranging from greater than 0 wt % to less than 5 wt %, based upon the total weight of the build material composition.

### Kits for 3D Printing

The build material composition described herein may be part of a 3D printing kit. In some examples, the kit for three-dimensional (3D) printing, comprises: a build material composition including a glass core coated with a polyamide material; a fusing agent to be applied to a portion of the build material composition during 3D printing, the fusing agent including a radiation absorber to absorb radiation to melt or fuse the polyamide material in the portion; and a detailing agent to be applied to another portion of the build material composition during 3D printing. The detailing agent may include a co-solvent and water to provide an evaporative cooling effect to the build material composition in the other portion. In one of these examples, the kit consists of the build material composition, the fusing agent, and the detailing agent with no other components. In another one of these examples, the kit further comprises a coloring agent.

In some other examples, the kit for three-dimensional (3D) printing comprises: a build material composition including a glass core coated with a polyamide material, wherein a surface of the glass core is modified with a functional group selected from the group consisting of an acrylate functional silane, a methacrylate functional silane, an epoxy functional silane, an ester functional silane, an amino functional silane, and a combination thereof; and a fusing agent to be applied to at least a portion of the build material composition during 3D printing, the fusing agent including a radiation absorber to absorb radiation to melt or fuse the polyamide material in the at least the portion. In one of these examples, the kit consists of the build material composition and the fusing agent with no other components. In another one of these examples, the kit further comprises a detailing agent and/or a coloring agent.

In still some other examples, the kit for three-dimensional (3D) printing comprises: a build material composition including a glass core coated with a polyamide material, the polyamide material being selected from the group consisting of polyamide 11, polyamide 6, polyamide 13, and a combination thereof; and a fusing agent to be applied to at least a portion of the build material composition during 3D printing, the fusing agent including a radiation absorber to absorb radiation to melt or fuse the polyamide material in the at least the portion. In one of these examples, the kit consists of the build material composition and the fusing agent with no other components. In another one of these examples, the kit further comprises a detailing agent and/or a coloring agent.

In any of the examples of the 3D printing kit disclosed herein, the components of the kit may be maintained separately until used together in examples of the 3D printing method disclosed herein.

### Printing Methods

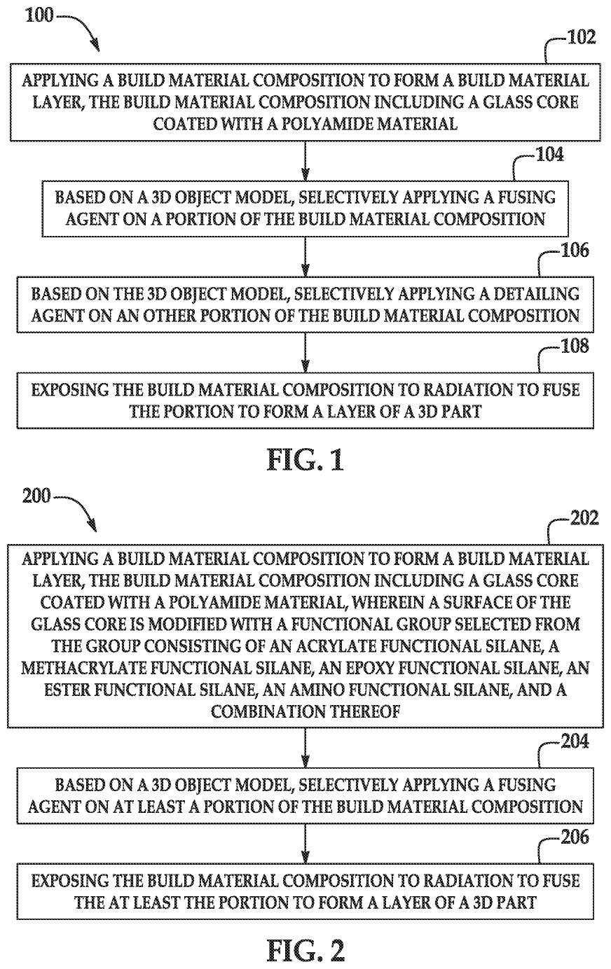

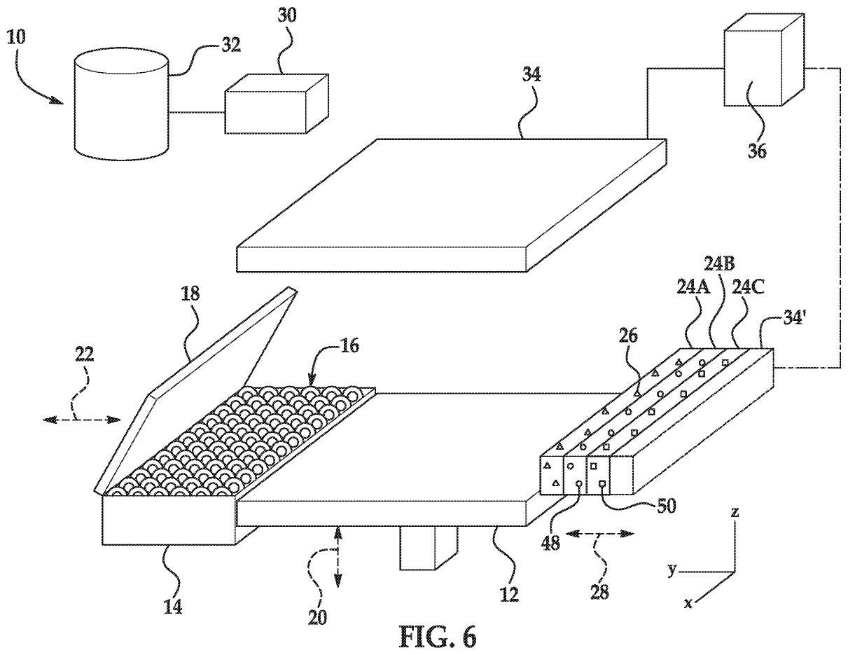

Referring now to FIGS. 1 through 3 and FIGS. 4A through 4E, examples of methods 100, 200, 300, 400 for 3D printing are depicted. Prior to execution of any of the methods 100, 200, 300, 400 disclosed herein or as part of the methods 100, 200, 300, 400, a controller 30 (see, e.g., FIG. 6) may access data stored in a data store 32 (see, e.g., FIG. 6) pertaining to a 3D part that is to be printed. The controller 30 may determine the number of layers of the build material composition 16 that are to be formed and the locations at which the fusing agent 26 from the first applicator 24A is to be deposited on each of the respective layers.

As shown in FIG. 1, the method 100 for three-dimensional (3D) printing comprises: applying a build material composition 16 to form a build material layer 38, the build material composition 16 including a glass core 15 coated with a polyamide material 17 (reference numeral 102); based on a 3D object model, selectively applying a fusing agent 26 on a portion 40 of the build material composition 16 (reference numeral 104); based on the 3D object model, selectively applying a detailing agent 48 on another portion 42 of the build material composition 16 (reference numeral 106); and exposing the build material composition 16 to radiation 44 to fuse the portion 40 to form a layer 46 of a 3D part (reference numeral 108).

As shown in FIG. 2, the method 200 for three-dimensional (3D) printing comprises: applying a build material composition 16 to form a build material layer 38, the build material composition 16 including a glass core 15 coated with a polyamide material 17, wherein a surface of the glass core 15 is modified with a functional group selected from the group consisting of an acrylate functional silane, a methacrylate functional silane, an epoxy functional silane, an ester functional silane, an amino functional silane, and a combination thereof (reference numeral 202); based on a 3D object model, selectively applying a fusing agent 26 on at least a portion 40 of the build material composition 16 (reference numeral 204); and exposing the build material composition 16 to radiation 44 to fuse the at least the portion 40 to form a layer 46 of a 3D part (reference numeral 206).

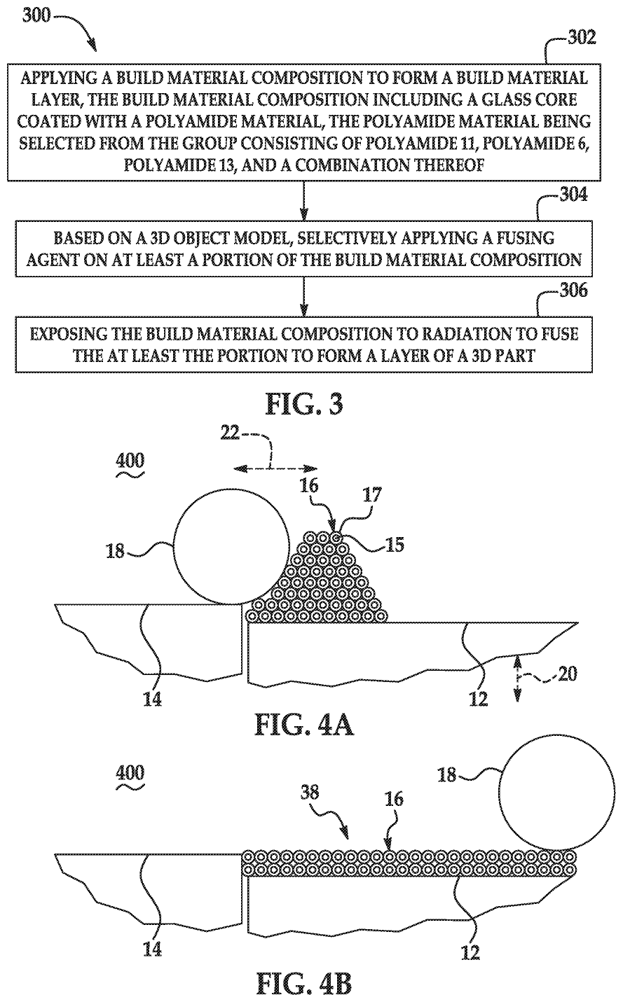

As shown in FIG. 3, the method 300 for three-dimensional (3D) printing comprises: applying a build material composition 16 to form a build material layer 38, the build material composition 16 including a glass core 15 coated with a polyamide material 17, the polyamide material 17 being selected from the group consisting of polyamide 11, polyamide 6, polyamide 13, and a combination thereof (reference numeral 302); based on a 3D object model, selectively applying a fusing agent 26 on at least a portion 40 of the build material composition 16 (reference numeral 304); and exposing the build material composition 16 to radiation 44 to fuse the at least the portion 40 to form a layer 46 of a 3D part (reference numeral 306).

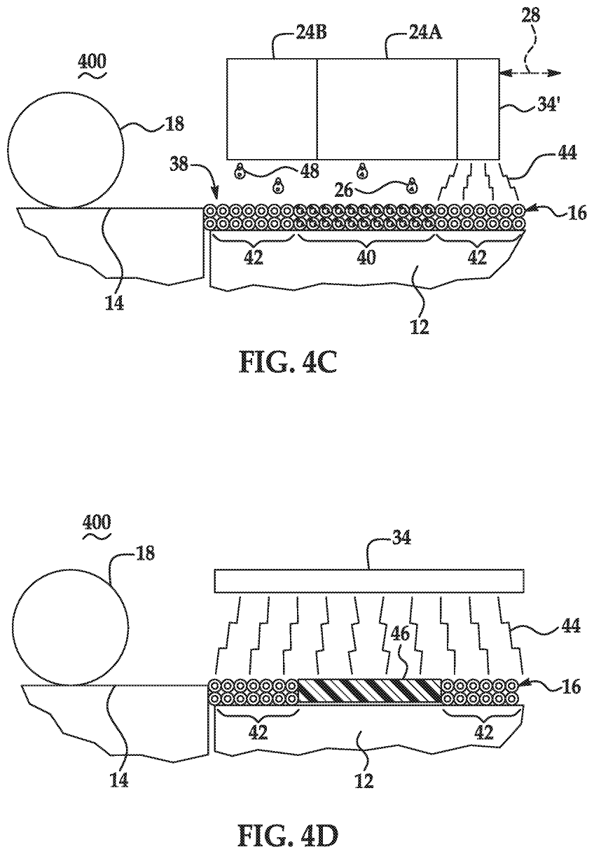

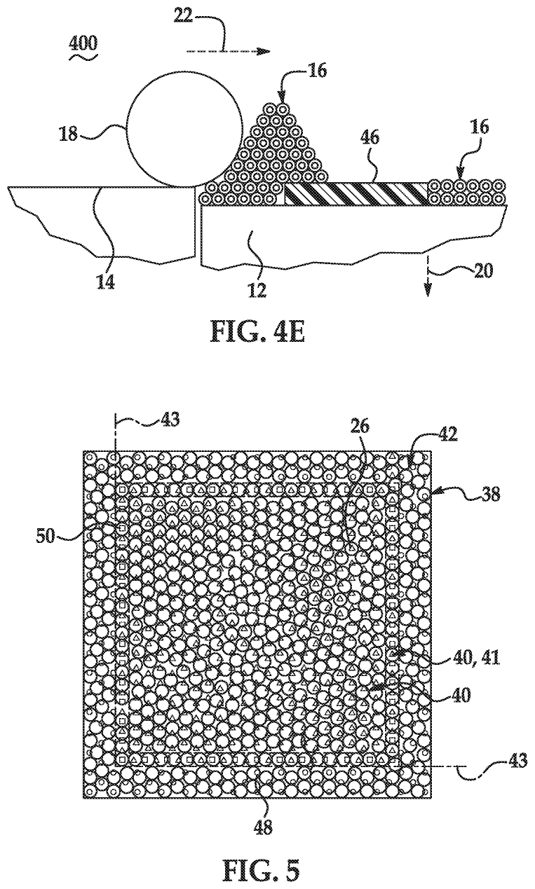

As shown at reference numeral 102 in FIG. 1, at reference numeral 202 in FIG. 2, at reference numeral 302 in FIG. 3, and in FIGS. 4A and 4B, the methods 100, 200, 300, 400 include applying the build material composition 16 to form the build material layer 38. As mentioned above, the build material composition 16 includes at least the glass core 15 coated with the polyamide material 17, and may additionally include the filler, the antioxidant, the brightener, the charging agent, the flow aid, or combinations thereof. In the method 200, the surface of the glass core 15 is modified with a functional group selected from the group consisting of an acrylate functional silane, a methacrylate functional silane, an epoxy functional silane, an ester functional silane, an amino functional silane, and a combination thereof. In the method 300, the polyamide material 17 is selected from the group consisting of polyamide 11, polyamide 6, polyamide 13, and a combination thereof.

In the example shown in FIGS. 4A and 4B, a printing system (e.g., the printing system 10 shown in FIG. 6) may be used to apply the build material composition 16. The printing system 10 may include a build area platform 12, a build material supply 14 containing the build material composition 16, and a build material distributor 18.

The build area platform 12 receives the build material composition 16 from the build material supply 14. The build area platform 12 may be moved in the directions as denoted by the arrow 20, e.g., along the z-axis, so that the build material composition 16 may be delivered to the build area platform 12 or to a previously formed layer 46. In an example, when the build material composition 16 is to be delivered, the build area platform 12 may be programmed to advance (e.g., downward) enough so that the build material distributor 18 can push the build material composition 16 onto the build area platform 12 to form a substantially uniform layer 38 of the build material composition 16 thereon. The build area platform 12 may also be returned to its original position, for example, when a new part is to be built.

The build material supply 14 may be a container, bed, or other surface that is to position the build material composition 16 between the build material distributor 18 and the build area platform 12.

The build material distributor 18 may be moved in the directions as denoted by the arrow 22, e.g., along the y-axis, over the build material supply 14 and across the build area platform 12 to spread the layer 38 of the build material composition 16 over the build area platform 12. The build material distributor 18 may also be returned to a position adjacent to the build material supply 14 following the spreading of the build material composition 16. The build material distributor 18 may be a blade (e.g., a doctor blade), a roller, a combination of a roller and a blade, and/or any other device capable of spreading the build material composition 16 over the build area platform 12. For instance, the build material distributor 18 may be a counter-rotating roller. In some examples, the build material supply 14 or a portion of the build material supply 14 may translate along with the build material distributor 18 such that build material composition 16 is delivered continuously to the material distributor 18 rather than being supplied from a single location at the side of the printing system 10 as depicted in FIG. 4A.

As shown in FIG. 4A, the build material supply 14 may supply the build material composition 16 into a position so that it is ready to be spread onto the build area platform 12. The build material distributor 18 may spread the supplied build material composition 16 onto the build area platform 12. The controller 30 may process control build material supply data, and in response, control the build material supply 14 to appropriately position the particles of the build material composition 16, and may process control spreader data, and in response, control the build material distributor 18 to spread the supplied build material composition 16 over the build area platform 12 to form the layer 38 of build material composition 16 thereon. As shown in FIG. 4B, one build material layer 38 has been formed.

The layer 38 of the build material composition 16 has a substantially uniform thickness across the build area platform 12. In an example, the thickness of the build material layer 38 is about 100 μm. In another example, the thickness of the build material layer 38 ranges from about 30 μm to about 300 μm, although thinner or thicker layers may also be used. For example, the thickness of the build material layer 38 may range from about 20 μm to about 500 μm, or from about 50 μm to about 80 μm. The layer thickness may be about 2× (i.e., 2 times) the coated material diameter (as shown in FIG. 4B) at a minimum for finer part definition. In some examples, the layer thickness may be about 1.2× the coated material diameter.

After the build material composition 16 has been applied, and prior to further processing, the build material layer 38 may be exposed to heating. Heating may be performed to pre-heat the build material composition 16, and thus the heating temperature may be below the melting point or softening point of the polyamide material of the build material composition 16. As such, the temperature selected will depend upon the build material composition 16 that is used. As examples, the pre-heating temperature may be from about 5° C. to about 50° C. below the melting point or softening point of the polyamide material of the build material composition 16. In an example, the pre-heating temperature ranges from about 50° C. to about 250° C. In another example, the pre-heating temperature ranges from about 150° C. to about 170° C.

Pre-heating the layer 38 of the build material composition 16 may be accomplished by using any suitable heat source that exposes all of the build material composition 16 on the build area platform 12 to the heat. Examples of the heat source include a thermal heat source (e.g., a heater (not shown) integrated into the build area platform 12 (which may include sidewalls)) or the radiation source 34, 34′ (see, e.g., FIG. 6).

As shown at reference numeral 104 in FIG. 1, at reference numeral 204 in FIG. 2, at reference numeral 304 in FIG. 3, and in FIG. 4C, the methods 100, 200, 300, 400 continue by selectively applying, based on a 3D object model, the fusing agent 26 on at least a portion 40 of the build material composition 16. Example compositions of the fusing agent 26 are described below.

It is to be understood that a single fusing agent 26 may be selectively applied on the portion 40, or multiple fusing agents 26 may be selectively applied on the portion 40. As an example, multiple fusing agents 26 may be used to create a multi-colored part. As another example, one fusing agent 26 may be applied to an interior portion of a layer and/or to interior layer(s) of a 3D part, and a second fusing agent 26 may be applied to the exterior portion(s) of the layer and/or to the exterior layer(s) of the 3D part. In the latter example, the color of the second fusing agent 26 will be exhibited at the exterior of the part.

As illustrated in FIG. 4C, the fusing agent 26 may be dispensed from the first applicator 24A. The first applicator 24A may be a thermal inkjet printhead, a piezoelectric printhead, a continuous inkjet printhead, etc., and the selective application of the fusing agent 26 may be accomplished by thermal inkjet printing, piezo electric inkjet printing, continuous inkjet printing, etc.

The controller 30 may process data, and in response, control the first applicator 24A (e.g., in the directions indicated by the arrow 28) to deposit the fusing agent 26 onto predetermined portion(s) 40 of the build material layer 38 that are to become part of the 3D part. The first applicator 24A may be programmed to receive commands from the controller 30 and to deposit the fusing agent 26 according to a pattern of a cross-section for the layer of the 3D part that is to be formed. As used herein, the cross-section of the layer of the 3D part to be formed refers to the cross-section that is parallel to the surface of the build area platform 12. In the example shown in FIG. 4C, the first applicator 24A selectively applies the fusing agent 26 on those portion(s) 40 of the build material layer 38 that is/are to become the first layer of the 3D part. As an example, if the 3D part that is to be formed is to be shaped like a cube or cylinder, the fusing agent 26 will be deposited in a square pattern or a circular pattern (from a top view), respectively, on at least a portion of the build material layer 38. In the example shown in FIG. 4C, the fusing agent 26 is deposited on the portion 40 of the build material layer 38 and not on the portions 42.

The volume of the fusing agent 26 that is applied per unit of the build material composition 16 in the patterned portion 40 may be sufficient to absorb and convert enough radiation 44 so that the build material composition 16 in the patterned portion 40 will fuse/coalesce. The volume of the fusing agent 26 that is applied per unit of the build material composition 16 may depend, at least in part, on the radiation absorber used, the radiation absorber loading in the fusing agent 26, and the build material composition 16 used.

As shown at reference numeral 108 in FIG. 1, at reference numeral 206 in FIG. 2, at reference numeral 306 in FIG. 3, and in FIGS. 4C and 4D, the methods 100, 200, 300, 400 may continue by exposing the build material composition 16 to radiation 44 to fuse/coalesce the at least the portion 40 to form a layer 46 of a 3D part. The radiation 44 may be applied with the source 34 of radiation 44 as shown in FIG. 4D or with the source 34′ of radiation 44 as shown in FIG. 4C.

The fusing agent 26 enhances the absorption of the radiation 44, converts the absorbed radiation 44 to thermal energy, and promotes the transfer of the thermal heat to the build material composition 16 in contact therewith. In an example, the fusing agent 26 sufficiently elevates the temperature of the build material composition 16 in the layer 38 above the melting or softening point of the polyamide material of the build material composition 16, allowing fusing/coalescing (e.g., thermal merging, melting, binding, etc.) of the build material composition 16 to take place. The application of the radiation 44 forms the fused layer 46, shown in FIG. 4D. While not shown in FIG. 4D, the fused layer 46 includes the glass core particles embedded in the fused polyamide material.

It is to be understood that portions 42 of the build material layer 38 that do not have the fusing agent 26 applied thereto do not absorb enough radiation 44 to fuse/coalesce. As such, these portions 42 do not become part of the 3D part that is ultimately formed. The build material composition 16 in portions 42 may be reclaimed to be reused as build material in the printing of another 3D part.

In some examples, the methods 100, 200, 300, 400 further comprise repeating the applying of the build material composition 16, the selectively applying of the fusing agent 26, and the exposing of the build material composition 16, wherein the repeating forms the 3D part including the layer 46. In these examples, the processes shown in FIGS. 1 through 3 and FIGS. 4A through 4D may be repeated to iteratively build up several fused layers and to form the 3D printed part.

FIG. 4E illustrates the initial formation of a second build material layer on the previously formed layer 46. In FIG. 4E, following the fusing/coalescing of the predetermined portion(s) 40 of the build material composition 16, the controller 30 may process data, and in response, cause the build area platform 12 to be moved a relatively small distance in the direction denoted by the arrow 20. In other words, the build area platform 12 may be lowered to enable the next build material layer to be formed. For example, the build material platform 12 may be lowered a distance that is equivalent to the height of the build material layer 38. In addition, following the lowering of the build area platform 12, the controller 30 may control the build material supply 14 to supply additional build material composition 16 (e.g., through operation of an elevator, an auger, or the like) and the build material distributor 18 to form another build material layer on top of the previously formed layer 46 with the additional build material composition 16. The newly formed build material layer may be in some instances pre-heated, patterned with the fusing agent 26, and then exposed to radiation 44 from the source 34, 34′ of radiation 44 to form the additional fused layer.

Several variations of the previously described methods 100, 200, 300, 400 will now be described.

In some examples of the methods 100, 200, 300, 400, a detailing agent 48 may be used. The composition of the detailing agent 48 will be described below. The detailing agent 48 may be dispensed from another (e.g., a second) applicator 24B (which may be similar to applicator 24A) and applied to portion(s) of the build material composition 16.

The detailing agent 48 may provide an evaporative cooling effect to the build material composition 16 to which it is applied. The cooling effect of the detailing agent 48 reduces the temperature of the build material composition 16 containing the detailing agent 48 during energy/radiation exposure. The detailing agent 48, and its rapid cooling effect, may be used to obtain different levels of melting/fusing/binding within the layer 46 of the 3D part that is being formed. Different levels of melting/fusing/binding may be desirable to control internal stress distribution, warpage, mechanical strength performance, and/or elongation performance of the final 3D part.

In an example of using the detailing agent 48 to obtain different levels of melting/fusing/binding within the layer 46, the fusing agent 26 may be selectively applied according to the pattern of the cross-section for the layer 46 of the 3D part, and the detailing agent 48 may be selectively applied on at least some of that cross-section. As such, some examples of the methods 100, 200, 300, 400 further comprise selectively applying, based on the 3D object model, the detailing agent 48 on the at least some of the portion 40 (or the at least the portion 40) of the build material composition 16. The evaporative cooling provided by the detailing agent 48 may remove energy from the at least some of the portion 40; however, since the fusing agent 26 is present with the detailing agent 48, fusing is not completely prevented. The level of fusing may be altered due to the evaporative cooling, which may alter the internal stress distribution, warpage, mechanical strength performance, and/or elongation performance of the 3D part. It is to be understood that when the detailing agent 48 is applied within the same portion 40 as the fusing agent 26, the detailing agent 48 may be applied in any desirable pattern. The detailing agent 48 may be applied before, after, or at least substantially simultaneously (e.g., one immediately after the other in a single printing pass, or at the same time) with the fusing agent 26, and then the build material composition 16 is exposed to radiation.

In some examples, the detailing agent 48 may also or alternatively be applied after the layer 46 is fused to control thermal gradients within the layer 46 and/or the final 3D part. In these examples, the thermal gradients may be controlled with the evaporative cooling provided by the detailing agent 48.

In another example that utilizes the evaporative cooling effect of the detailing agent 48, the methods 100, 200, 300, 400 further comprise selectively applying the detailing agent 48 on another portion 42 of the build material composition 16 to aid in preventing the build material composition 16 in the other portion 42 from fusing. An example of this is shown in FIG. 1, at reference numeral 106, and in FIG. 4C. While the example shown in FIG. 4C shows the detailing agent 48 being applied on the other portion 42, the detailing agent 48 is not actually shown among the build material composition 16 in the other portion 42. It is to be understood that when the detailing agent 48 is applied on the other portion 42, the detailing agent 48 may remain in the other portion 42 until the detailing agent 48 evaporates from the build material layer 38.

In these examples, the detailing agent 48 is selectively applied, based on the 3D object model, on the other portion(s) 42 of the build material composition 16. The evaporative cooling provided by the detailing agent 48 may remove energy from the other portion 42, which may lower the temperature of the build material composition 16 in the other portion 42 and prevent the build material composition 16 in the other portion 42 from fusing/coalescing.

In some examples of the methods 100, 200, 300, 400, a coloring agent 50 (see, e.g., FIGS. 5 and 6) may be used. The coloring agent 50 may be selected from the group consisting of a black ink, a cyan ink, a magenta ink, and a yellow ink. The composition of the coloring agent 50 will be described below. The coloring agent 50 may be dispensed from another (e.g., a third) applicator 24C (which may be similar to applicator 24A see, e.g., FIGS. 6) and applied to portion(s) of the build material composition 16.

The coloring agent 50 may color the build material composition 16 to which it is applied. The color of the coloring agent 50 may then be exhibited by the 3D part. The coloring agent 50 may be used to obtain colored or multicolored 3D printed parts.

In an example, the fusing agent 26 may be selectively applied according to the pattern of the cross-section for the layer 46 of the 3D part, and the coloring agent 50 may be selectively applied on at least some 41 (see, e.g., FIG. 5) of that cross-section. As such, some examples of the methods 100, 200, 300, 400 further comprise selectively applying, based on the 3D object model, the coloring agent 50 on the at least some 41 of the portion 40 (or the at least the portion 40) of the build material composition 16, the coloring agent 50 being selected from the group consisting of a black ink, a cyan ink, a magenta ink, and a yellow ink. The coloring agent 50 may cause the 3D part to exhibit the color (e.g., black, cyan, magenta, yellow, etc.) of the coloring agent 50. Multiple coloring agents 50 may be used to impart multiple colors to the 3D part. It is to be understood that when the coloring agent(s) 50 is/are applied within the same portion 40 as the fusing agent 26, the coloring agent(s) 50 may be applied in any desirable pattern. The coloring agent 50 may be applied before, after, or at least substantially simultaneously (e.g., one immediately after the other in a single printing pass, or at the same time) with the fusing agent 26, and then the build material composition 16 is exposed to radiation. In other examples, the coloring agent(s) 50 may be applied to the finished 3D part. In these examples, the coloring agent(s) may be used to add color(s) to the exterior of the part.

A top view of the build material composition 16 on the build area platform 12 is shown in FIG. 5. In the example shown in this figure, the shape of the 3D part layer to be formed is a cube or a rectangular prism, and the pattern of the cross-section that is parallel to the surface of the build area platform 12 is a square or rectangle having an edge boundary 43. In the example shown in FIG. 5, the portion 40 has the fusing agent 26 applied thereon. The portion 40 forms the layer 46 of the 3D part. The build material composition 16 within the edge boundary 43 is the at least some 41 of the portion 40. In the example shown in FIG. 5, the at least some 41 of the portion 40 has the coloring agent 50 applied thereon, in addition to the fusing agent 26. The build material composition 16 positioned outside of the portion 40 is the build material composition 16 within the other portion 42. In the example shown in FIG. 5, the other portion 42 has the detailing agent 48 applied thereon.

In some examples, the methods 100, 200, 300, 400 further comprise, upon completion of the 3D part, placing the 3D part in an environment having a temperature ranging from about 15° C. to 30° C.; and maintaining the 3D part in the environment until a temperature of the 3D part reaches the temperature of the environment. In these examples, the 3D part is allowed to cool in a room temperature environment (e.g., a temperature ranging from about 15° C. to 30° C.) upon completion of the build (e.g., within about 5 minutes of forming the 3D part). As such, these examples of the methods 100, 200, 300, 400 may be faster than examples that include heating the 3D part after its formation (i.e., exposing the 3D part to an aging process).

In other examples, the methods 100, 200, 300, 400 further comprise heating the 3D part at a temperature ranging from greater than 30° C. to about 177° C. for a time period ranging from greater than 0 hours to about 144 hours. In an example, the 3D part is heated at a temperature ranging from about 130° C. to about 177° C. In another example, the 3D part is heated at a temperature ranging from about 150° C. to about 177° C. In still another example, the 3D part is heated a temperature ranging from about 165° C. to about 177° C. In yet another example, the 3D part is heated a temperature of about 165° C. In another example, the 3D part is heated for a time period ranging from greater than 0 hours to about 48 hours. In still another example, the 3D part is heated for about 22 hours. The time period for which the 3D part is heated may depend, in part, on the temperature at which the 3D part is heated. For example, when the temperature at which the 3D part is heated is higher (e.g., 165° C.) the time period for which the 3D part is heated may be shorter (e.g., 22 hours). As another example, when the temperature at which the 3D part is heated is lower (e.g., 35° C.) the time period for which the 3D part is heated may be longer (e.g., 140 hours).

Heating may be accomplished by any suitable means. For example, the 3D part may be heated in an oven. Heating the 3D part after its formation may increase the ultimate tensile strength of the 3D part (as compared to ultimate tensile strength of a 3D part that was allowed to cool in a room temperature environment upon completion of the build).

In one specific example, the method 100 further comprises: repeating the applying of the build material composition 16, the selectively applying of the fusing agent 26, the selectively applying of the detailing agent 48, and the exposing of the build material composition 16, wherein the repeating forms the 3D part including the layer 46; and heating the 3D part at a temperature ranging from greater than 30° C. to about 177° C. for a time period ranging from greater than 0 hours to about 144 hours.

### Printing System

Referring now to FIG. 6, an example of a 3D printing system 10 is schematically depicted. It is to be understood that the 3D printing system 10 may include additional components (some of which are described herein) and that some of the components described herein may be removed and/or modified. Furthermore, components of the 3D printing system 10 depicted in FIG. 6 may not be drawn to scale and thus, the 3D printing system 10 may have a different size and/or configuration other than as shown therein.

In an example, the three-dimensional (3D) printing system 10, comprises: a supply 14 of a build material composition 16 including a glass core 15 coated with a polyamide material 17; a build material distributor 18; a supply of a fusing agent 26; a first applicator 24A for selectively dispensing the fusing agent 26; a source 34, 34′ of radiation 44; a controller 30; and a non-transitory computer readable medium having stored thereon computer executable instructions to cause the controller 30 to: utilize the build material distributor 18 to dispense the build material composition 16; utilize the first applicator 24A to selectively dispense the fusing agent 26 on at least a portion 40 of the build material composition 16; and utilize the source 34, 34′ of radiation 44 to expose the build material composition 16 to radiation 44 to fuse/coalesce the at least the portion 40 of the build material composition 16. Any example of the build material composition 16 may be used in the examples of the system 10.

In some examples, the 3D printing system 10 may further include a supply of a detailing agent 48; a second applicator 24B for selectively dispensing the detailing agent 48; a supply of a coloring agent 50; and/or a third applicator 24C for selectively dispensing the coloring agent 50. In these examples, the computer executable instructions may further cause the controller 30 to utilize the second applicator 24B to selectively dispense the detailing agent 48; and/or utilize the third applicator 24C to selectively dispense the coloring agent 50 on at least some 41 of the at least the portion 40.

As shown in FIG. 6, the printing system 10 includes the build area platform 12, the build material supply 14 containing the build material composition 16 including the glass core 15 coated with the polyamide material 17, and the build material distributor 18.

As mentioned above, the build area platform 12 receives the build material composition 16 from the build material supply 14. The build area platform 12 may be integrated with the printing system 10 or may be a component that is separately insertable into the printing system 10. For example, the build area platform 12 may be a module that is available separately from the printing system 10. The build material platform 12 that is shown is one example, and could be replaced with another support member, such as a platen, a fabrication/print bed, a glass plate, or another build surface.

As also mentioned above, the build material supply 14 may be a container, bed, or other surface that is to position the build material composition 16 between the build material distributor 18 and the build area platform 12. In some examples, the build material supply 14 may include a surface upon which the build material composition 16 may be supplied, for instance, from a build material source (not shown) located above the build material supply 14. Examples of the build material source may include a hopper, an auger conveyer, or the like. Additionally, or alternatively, the build material supply 14 may include a mechanism (e.g., a delivery piston) to provide, e.g., move, the build material composition 16 from a storage location to a position to be spread onto the build area platform 12 or onto a previously formed layer 46 of the 3D part.

As also mentioned above, the build material distributor 18 may be a blade (e.g., a doctor blade), a roller, a combination of a roller and a blade, and/or any other device capable of spreading the build material composition 16 over the build area platform 12 (e.g., a counter-rotating roller).

As shown in FIG. 6, the printing system 10 includes the first applicator 24A, which may contain the fusing agent 26. As also shown, the printing system 10 may further include the second applicator 24B (which may contain the detailing agent 48) and the third applicator 24C (which may contain the coloring agent 50).

The applicator(s) 24A, 24B, 24C may be scanned across the build area platform 12 in the directions indicated by the arrow 28, e.g., along the y-axis. The applicator(s) 24A, 24B, 24C may be, for instance, a thermal inkjet printhead, a piezoelectric printhead, a continuous inkjet printhead, etc., and may extend a width of the build area platform 12. While the each applicator 24A, 24B, 24C is shown in FIG. 6 as a single applicator, it is to be understood that each applicator 24A, 24B, 24C may include multiple applicators that span the width of the build area platform 12. Additionally, the applicators 24A, 24B, 24C may be positioned in multiple printbars. The applicator(s) 24A, 24B, 24C may also be scanned along the x-axis, for instance, in configurations in which the applicator(s) 24A, 24B, 24C do/does not span the width of the build area platform 12 to enable the applicator(s) 24A, 24B, 24C to deposit the respective agents 26, 48, 50 over a large area of the build material composition 16. The applicator(s) 24A, 24B, 24C may thus be attached to a moving XY stage or a translational carriage (neither of which is shown) that moves the applicator(s) 24A, 24B, 24C adjacent to the build area platform 12 in order to deposit the respective agents 26, 48, 50 in predetermined areas of the build material layer 38 that has been formed on the build area platform 12 in accordance with the methods 100, 200, 300, 400 disclosed herein. The applicator(s) 24A, 24B, 24C may include a plurality of nozzles (not shown) through which the respective agents 26, 48, 50 are to be ejected.

The applicator(s) 24A, 24B, 24C may deliver drops of the respective agents 26, 48, 50 at a resolution ranging from about 300 dots per inch (DPI) to about 1200 DPI. In other examples, the applicator(s) 24A, 24B, 24C may deliver drops of the respective agents 26, 48, 50 at a higher or lower resolution. The drop velocity may range from about 5 m/s to about 24 m/s and the firing frequency may range from about 1 kHz to about 100 kHz. In one example, the volume of each drop may be on the order of about 3 picoliters (pl) to about 18 pl, although it is contemplated that a higher or lower drop volume may be used. In some examples, the applicator(s) 24A, 24B, 24C is/are able to deliver variable drop volumes of the respective agents 26, 48, 50. One example of a suitable printhead has 600 DPI resolution and can deliver drop volumes ranging from about 6 pl to about 14 pl.

Each of the previously described physical elements may be operatively connected to a controller 30 of the printing system 10. The controller 30 may process print data that is based on a 3D object model of the 3D object/part to be generated. In response to data processing, the controller 30 may control the operations of the build area platform 12, the build material supply 14, the build material distributor 18, and the applicator(s) 24A, 24B, 24C. As an example, the controller 30 may control actuators (not shown) to control various operations of the 3D printing system 10 components. The controller 30 may be a computing device, a semiconductor-based microprocessor, a central processing unit (CPU), an application specific integrated circuit (ASIC), and/or another hardware device. Although not shown, the controller 30 may be connected to the 3D printing system 10 components via communication lines.

The controller 30 manipulates and transforms data, which may be represented as physical (electronic) quantities within the printer's registers and memories, in order to control the physical elements to create the 3D part. As such, the controller 30 is depicted as being in communication with a data store 32. The data store 32 may include data pertaining to a 3D part to be printed by the 3D printing system 10. The data for the selective delivery of the build material composition 16, the fusing agent 26, etc. may be derived from a model of the 3D part to be formed. For instance, the data may include the locations on each build material layer 38 that the first applicator 24A is to deposit the fusing agent 26. In one example, the controller 30 may use the data to control the first applicator 24A to selectively apply the fusing agent 26. The data store 32 may also include machine readable instructions (stored on a non-transitory computer readable medium) that are to cause the controller 30 to control the amount of build material composition 16 that is supplied by the build material supply 14, the movement of the build area platform 12, the movement of the build material distributor 18, the movement of the applicator(s) 24A, 24B, 24C, etc.

As shown in FIG. 6, the printing system 10 may also include a source 34, 34′ of radiation 44. In some examples, the source 34 of radiation 44 may be in a fixed position with respect to the build material platform 12. The source 34 in the fixed position may be a conductive heater or a radiative heater that is part of the printing system 10. These types of heaters may be placed below the build area platform 12 (e.g., conductive heating from below the platform 12) or may be placed above the build area platform 12 (e.g., radiative heating of the build material layer surface). In other examples, the source 34′ of radiation 44 may be positioned to apply radiation 44 to the build material composition 16 immediately after the fusing agent 26 has been applied thereto. In the example shown in FIG. 6, the source 34′ of radiation 44 is attached to the side of the applicators 24A, 24B, 24C which allows for patterning and heating/exposing to radiation 44 in a single pass.

The source 34, 34′ of radiation 44 may emit radiation 44 having wavelengths ranging from about 100 nm to about 1 mm. As one example, the radiation 44 may range from about 800 nm to about 2 μm. As another example, the radiation 44 may be blackbody radiation with a maximum intensity at a wavelength of about 1100 nm. The source 34, 34′ of radiation 44 may be infrared (IR) or near-infrared light sources, such as IR or near-IR curing lamps, IR or near-IR light emitting diodes (LED), or lasers with the desirable IR or near-IR electromagnetic wavelengths.

The source 34, 34′ of radiation 44 may be operatively connected to a lamp/laser driver, an input/output temperature controller, and temperature sensors, which are collectively shown as radiation system components 36. The radiation system components 36 may operate together to control the source 34, 34′ of radiation 44. The temperature recipe (e.g., radiation exposure rate) may be submitted to the input/output temperature controller. During heating, the temperature sensors may sense the temperature of the build material composition 16, and the temperature measurements may be transmitted to the input/output temperature controller. For example, a thermometer associated with the heated area can provide temperature feedback. The input/output temperature controller may adjust the source 34, 34′ of radiation 44 power set points based on any difference between the recipe and the real-time measurements. These power set points are sent to the lamp/laser drivers, which transmit appropriate lamp/laser voltages to the source 34, 34′ of radiation 44. This is one example of the radiation system components 36, and it is to be understood that other radiation source control systems may be used. For example, the controller 30 may be configured to control the source 34, 34′ of radiation 44.

### Fusing Agents

In the examples of the methods 100, 200, 300, 400 and the system 10 disclosed herein, and as mentioned above, a fusing agent 26 may be used. Some examples of the fusing agent 26 are dispersions including a radiation absorber (i.e., an active material). In some examples, the active material may be any infrared light absorbing colorant. In an example, the active material is a near-infrared light absorber. Any near-infrared colorants, e.g., those produced by Fabricolor, Eastman Kodak, or Yamamoto, may be used in the fusing agent 26. As one example, the fusing agent 26 may be a printing liquid formulation including carbon black as the active material. Examples of this printing liquid formulation are commercially known as CM997A, 516458, C18928, C93848, C93808, or the like, all of which are available from HP Inc.

Other suitable active materials include near-infrared absorbing dyes or plasmonic resonance absorbers.

As another example, the fusing agent 26 may be a printing liquid formulation including near-infrared absorbing dyes as the active material. Examples of this printing liquid formulation are described in U.S. Pat. No. 9,133,344, incorporated herein by reference in its entirety. Some examples of the near-infrared absorbing dye are water-soluble near-infrared absorbing dyes selected from the group consisting of:

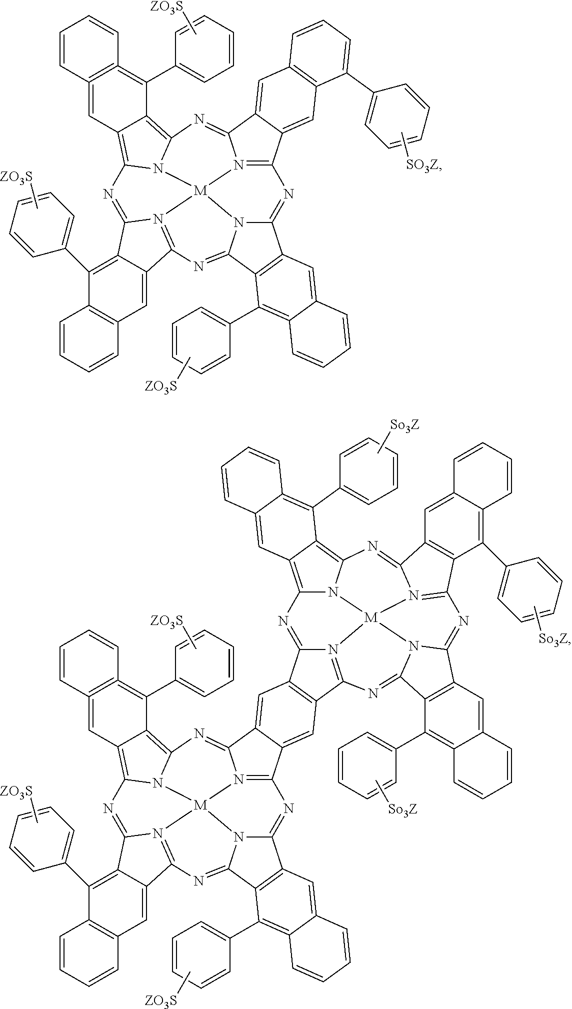

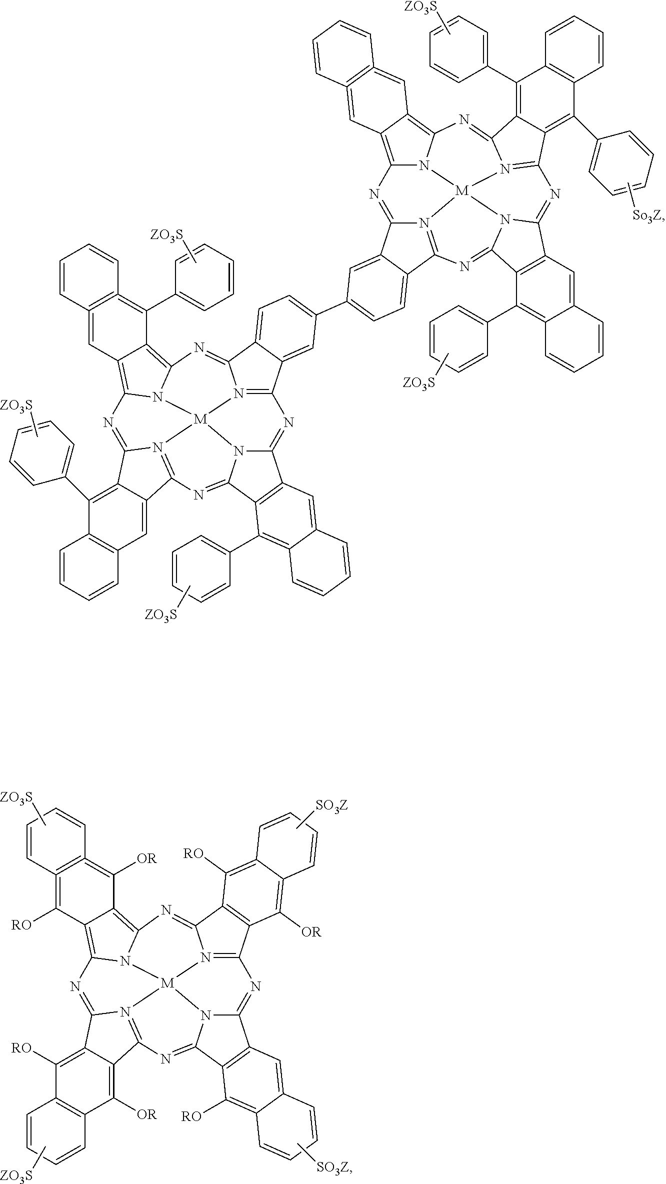

and mixtures thereof. In the above formulations, M can be a divalent metal atom (e.g., copper, etc.) or can have OSO₃Na axial groups filling any unfilled valencies if the metal is more than divalent (e.g., indium, etc.), R can be hydrogen or any C₁-C₈ alkyl group (including substituted alkyl and unsubstituted alkyl), and Z can be a counterion such that the overall charge of the near-infrared absorbing dye is neutral. For example, the counterion can be sodium, lithium, potassium, NH₄⁺, etc.

Some other examples of the near-infrared absorbing dye are hydrophobic near-infrared absorbing dyes selected from the group consisting of:

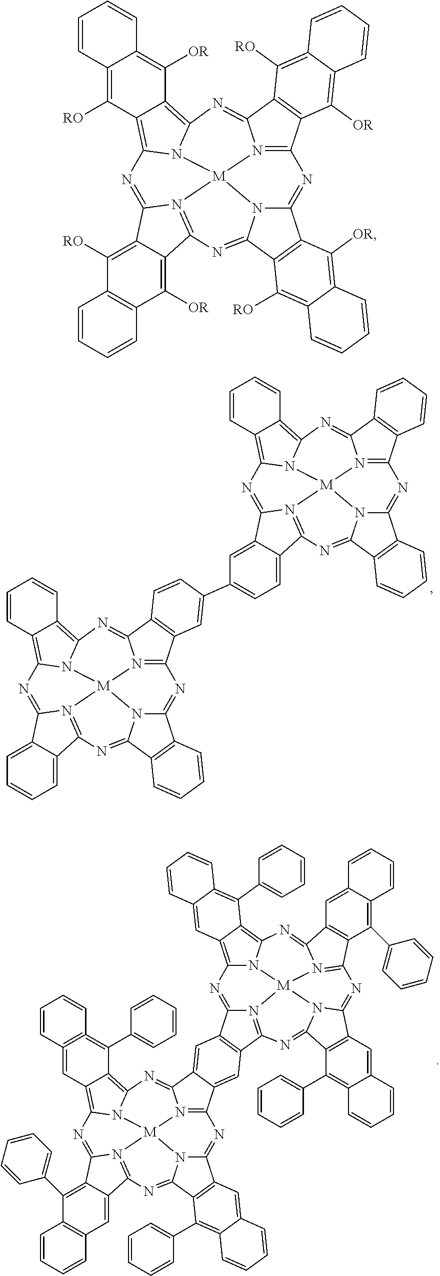

and mixtures thereof. For the hydrophobic near-infrared absorbing dyes, M can be a divalent metal atom (e.g., copper, etc.) or can include a metal that has Cl, Br, or OR′ (R′═H, CH₃, COCH₃, COCH₂COOCH₃, COCH₂COCH₃) axial groups filling any unfilled valencies if the metal is more than divalent, and R can be hydrogen or any C₁-C₈ alkyl group (including substituted alkyl and unsubstituted alkyl).

Other near-infrared absorbing dyes or pigments may be used. Some examples include anthroquinone dyes or pigments, metal dithiolene dyes or pigments, cyanine dyes or pigments, perylenediimide dyes or pigments, croconium dyes or pigments, pyrilium or thiopyrilium dyes or pigments, boron-dipyrromethene dyes or pigments, or aza-boron-dipyrromethene dyes or pigments.

Anthroquinone dyes or pigments and metal (e.g., nickel) dithiolene dyes or pigments may have the following structures, respectively:

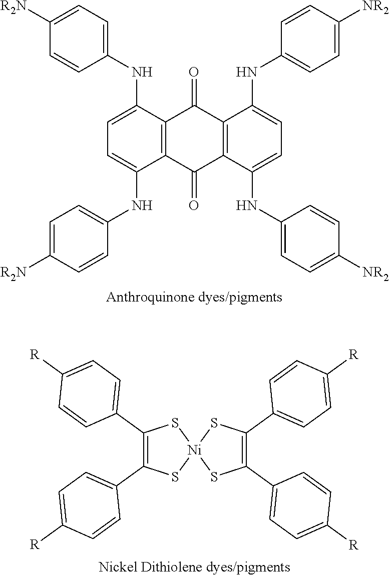

where R in the anthroquinone dyes or pigments may be hydrogen or any C₁-C₈ alkyl group (including substituted alkyl and unsubstituted alkyl), and R in the dithiolene may be hydrogen, COOH, SO₃, NH₂, any C₁-C₈ alkyl group (including substituted alkyl and unsubstituted alkyl), or the like.

Cyanine dyes or pigments and perylenediimide dyes or pigments may have the following structures, respectively:

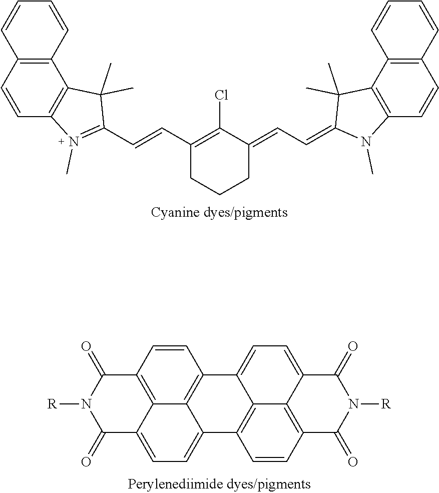

where R in the perylenediimide dyes or pigments may be hydrogen or any C₁-C₈ alkyl group (including substituted alkyl and unsubstituted alkyl).

Croconium dyes or pigments and pyrilium or thiopyrilium dyes or pigments may have the following structures, respectively:

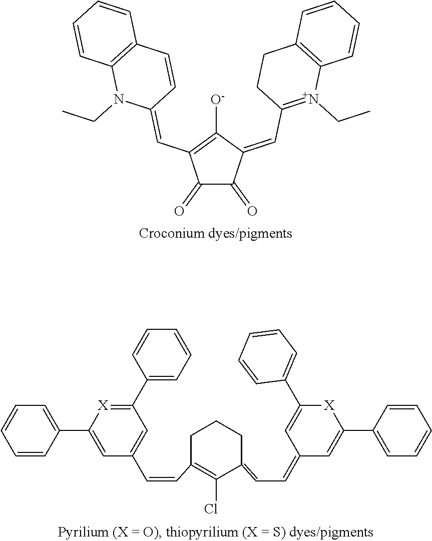

Boron-dipyrromethene dyes or pigments and aza-boron-dipyrromethene dyes or pigments may have the following structures, respectively:

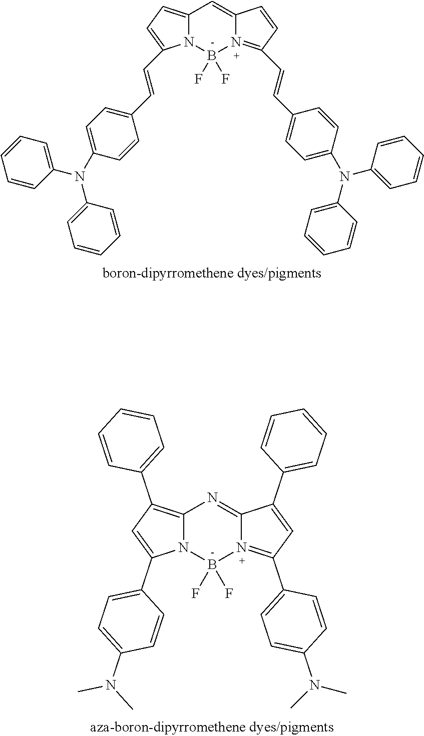

In other examples, the active material may be a plasmonic resonance absorber. The plasmonic resonance absorber allows the fusing agent 26 to absorb radiation at wavelengths ranging from 800 nm to 4000 nm (e.g., at least 80% of radiation having wavelengths ranging from 800 nm to 4000 nm is absorbed), which enables the fusing agent 26 to convert enough radiation to thermal energy so that the build material composition 16 fuses/coalesces. The plasmonic resonance absorber also allows the fusing agent 26 to have transparency at wavelengths ranging from 400 nm to 780 nm (e.g., 20% or less of radiation having wavelengths ranging from 400 nm to 780 nm is absorbed), which enables the 3D part to be white or slightly colored.

The absorption of the plasmonic resonance absorber is the result of the plasmonic resonance effects. Electrons associated with the atoms of the plasmonic resonance absorber may be collectively excited by radiation, which results in collective oscillation of the electrons. The wavelengths that can excite and oscillate these electrons collectively are dependent on the number of electrons present in the plasmonic resonance absorber particles, which in turn is dependent on the size of the plasmonic resonance absorber particles. The amount of energy that can collectively oscillate the particle's electrons is low enough that very small particles (e.g., 1-100 nm) may absorb radiation with wavelengths several times (e.g., from 8 to 800 or more times) the size of the particles. The use of these particles allows the fusing agent 26 to be inkjet jettable as well as electromagnetically selective (e.g., having absorption at wavelengths ranging from 800 nm to 4000 nm and transparency at wavelengths ranging from 400 nm to 780 nm).

In an example, the plasmonic resonance absorber has an average particle diameter (e.g., volume-weighted mean diameter) ranging from greater than 0 nm to less than 220 nm. In another example the plasmonic resonance absorber has an average particle diameter ranging from greater than 0 nm to 120 nm. In a still another example, the plasmonic resonance absorber has an average particle diameter ranging from about 10 nm to about 200 nm.

In an example, the plasmonic resonance absorber is an inorganic pigment. Examples of suitable inorganic pigments include lanthanum hexaboride (LaB₆), tungsten bronzes (AₓWO₃), indium tin oxide (In₂O₃:SnO₂, ITO), antimony tin oxide (Sb₂O₃:SnO₂, ATO), titanium nitride (TiN), aluminum zinc oxide (AZO), ruthenium oxide (RuO₂), silver (Ag), gold (Au), platinum (Pt), iron pyroxenes (AₓFe_{y}Si₂O₆ wherein A is Ca or Mg, x=1.5-1.9, and y=0.1-0.5), modified iron phosphates (AₓFe_{y}PO₄), modified copper phosphates (AₓCu_{y}PO_{z}), and modified copper pyrophosphates (AₓCu_{y}P₂O₇). Tungsten bronzes may be alkali doped tungsten oxides. Examples of suitable alkali dopants (i.e., A in AₓWO₃) may be cesium, sodium, potassium, or rubidium. In an example, the alkali doped tungsten oxide may be doped in an amount ranging from greater than 0 mol % to about 0.33 mol % based on the total mol % of the alkali doped tungsten oxide. Suitable modified iron phosphates (AₓFe_{y}PO) may include copper iron phosphate (A=Cu, x=0.1-0.5, and y=0.5-0.9), magnesium iron phosphate (A=Mg, x=0.1-0.5, and y=0.5-0.9), and zinc iron phosphate (A=Zn, x=0.1-0.5, and y=0.5-0.9). For the modified iron phosphates, it is to be understood that the number of phosphates may change based on the charge balance with the cations. Suitable modified copper pyrophosphates (AₓCu_{y}P₂O₇) include iron copper pyrophosphate (A=Fe, x=0-2, and y=0-2), magnesium copper pyrophosphate (A=Mg, x=0-2, and y=0-2), and zinc copper pyrophosphate (A=Zn, x=0-2, and y=0-2). Combinations of the inorganic pigments may also be used.

The amount of the active material that is present in the fusing agent 26 ranges from greater than 0 wt % to about 40 wt % based on the total weight of the fusing agent 26. In other examples, the amount of the active material in the fusing agent 26 ranges from about 0.3 wt % to 30 wt %, from about 1 wt % to about 20 wt %, from about 1.0 wt % up to about 10.0 wt %, or from greater than 4.0 wt % up to about 15.0 wt %. It is believed that these active material loadings provide a balance between the fusing agent 26 having jetting reliability and heat and/or radiation absorbance efficiency.

As used herein, “FA vehicle” may refer to the liquid in which the active material is dispersed or dissolved to form the fusing agent 26. A wide variety of FA vehicles, including aqueous and non-aqueous vehicles, may be used in the fusing agent 26. In some examples, the FA vehicle may include water alone or a non-aqueous solvent alone with no other components. In other examples, the FA vehicle may include other components, depending, in part, upon the first applicator 24A that is to be used to dispense the fusing agent 26. Examples of other suitable fusing agent components include dispersant(s), silane coupling agent(s), co-solvent(s), surfactant(s), antimicrobial agent(s), anti-kogation agent(s), and/or chelating agent(s).

When the active material is the plasmonic resonance absorber, the plasmonic resonance absorber may, in some instances, be dispersed with a dispersant. As such, the dispersant helps to uniformly distribute the plasmonic resonance absorber throughout the fusing agent 26. Examples of suitable dispersants include polymer or small molecule dispersants, charged groups attached to the plasmonic resonance absorber surface, or other suitable dispersants. Some specific examples of suitable dispersants include a water-soluble acrylic acid polymer (e.g., CARBOSPERSE® K7028 available from Lubrizol), water-soluble styrene-acrylic acid copolymers/resins (e.g., JONCRYL® 296, JONCRYL® 671, JONCRYL® 678, JONCRYL® 680, JONCRYL® 683, JONCRYL® 690, etc. available from BASF Corp.), a high molecular weight block copolymer with pigment affinic groups (e.g., DISPERBYK®-190 available BYK Additives and Instruments), or water-soluble styrene-maleic anhydride copolymers/resins.

Whether a single dispersant is used or a combination of dispersants is used, the total amount of dispersant(s) in the fusing agent 26 may range from about 10 wt % to about 200 wt % based on the weight of the plasmonic resonance absorber in the fusing agent 26.

When the active material is the plasmonic resonance absorber, a silane coupling agent may also be added to the fusing agent 26 to help bond the organic and inorganic materials. Examples of suitable silane coupling agents include the SILQUEST® A series manufactured by Momentive.

Whether a single silane coupling agent is used or a combination of silane coupling agents is used, the total amount of silane coupling agent(s) in the fusing agent 26 may range from about 0.1 wt % to about 50 wt % based on the weight of the plasmonic resonance absorber in the fusing agent 26. In an example, the total amount of silane coupling agent(s) in the fusing agent 26 ranges from about 1 wt % to about 30 wt % based on the weight of the plasmonic resonance absorber. In another example, the total amount of silane coupling agent(s) in the fusing agent 26 ranges from about 2.5 wt % to about 25 wt % based on the weight of the plasmonic resonance absorber.

The solvent of the fusing agent 26 may be water or a non-aqueous solvent (e.g., ethanol, acetone, n-methyl pyrrolidone, aliphatic hydrocarbons, etc.). In some examples, the fusing agent 26 consists of the active material and the solvent (without other components). In these examples, the solvent makes up the balance of the fusing agent 26.

Classes of organic co-solvents that may be used in a water-based fusing agent 26 include aliphatic alcohols, aromatic alcohols, diols, glycol ethers, polyglycol ethers, 2-pyrrolidones, caprolactams, formamides, acetamides, glycols, and long chain alcohols. Examples of these co-solvents include primary aliphatic alcohols, secondary aliphatic alcohols, 1,2-alcohols, 1,3-alcohols, 1,5-alcohols, 1,6-hexanediol or other diols (e.g., 1,5-pentanediol, 2-methyl-1,3-propanediol, etc.), ethylene glycol alkyl ethers, propylene glycol alkyl ethers, higher homologs (C₆-C₁₂) of polyethylene glycol alkyl ethers, triethylene glycol, tetraethylene glycol, tripropylene glycol methyl ether, N-alkyl caprolactams, unsubstituted caprolactams, both substituted and unsubstituted formamides, both substituted and unsubstituted acetamides, and the like. Other examples of organic co-solvents include dimethyl sulfoxide (DMSO), isopropyl alcohol, ethanol, pentanol, acetone, or the like.

Other examples of suitable co-solvents include water-soluble high-boiling point solvents, which have a boiling point of at least 120° C., or higher. Some examples of high-boiling point solvents include 2-pyrrolidone (i.e., 2-pyrrolidinone, boiling point of about 245° C.), 1-methyl-2-pyrrolidone (boiling point of about 203° C.), N-(2-hydroxyethyl)-2-pyrrolidone (boiling point of about 140° C.), 2-methyl-1,3-propanediol (boiling point of about 212° C.), and combinations thereof.

The co-solvent(s) may be present in the fusing agent 26 in a total amount ranging from about 1 wt % to about 50 wt % based upon the total weight of the fusing agent 26, depending upon the jetting architecture of the first applicator 24A. In an example, the total amount of the co-solvent(s) present in the fusing agent 26 is 25 wt % based on the total weight of the fusing agent 26.

The co-solvent(s) of the fusing agent 26 may depend, in part, upon the jetting technology that is to be used to dispense the fusing agent 26. For example, if thermal inkjet printheads are to be used, water and/or ethanol and/or other longer chain alcohols (e.g., pentanol) may be the solvent (i.e., makes up 35 wt % or more of the fusing agent 26) or co-solvents. For another example, if piezoelectric inkjet printheads are to be used, water may make up from about 25 wt % to about 30 wt % of the fusing agent 26, and the solvent (i.e., 35 wt % or more of the fusing agent 26) may be ethanol, isopropanol, acetone, etc. The co-solvent(s) of the fusing agent 26 may also depend, in part, upon the build material composition 16 that is being used with the fusing agent 26. For a hydrophobic powder (e.g., a polyamide), the FA vehicle may include a higher solvent content in order to improve the flow of the fusing agent 26 into the build material composition 16.

The FA vehicle may also include humectant(s). In an example, the total amount of the humectant(s) present in the fusing agent 26 ranges from about 3 wt % to about 10 wt %, based on the total weight of the fusing agent 26. An example of a suitable humectant is LIPONIC® EG-1 (i.e., LEG-1, glycereth-26, ethoxylated glycerol, available from Lipo Chemicals).

In some examples, the FA vehicle includes surfactant(s) to improve the jettability of the fusing agent 26. Examples of suitable surfactants include a self-emulsifiable, non-ionic wetting agent based on acetylenic diol chemistry (e.g., SURFYNOL® SEF from Air Products and Chemicals, Inc.), a non-ionic fluorosurfactant (e.g., CAPSTONE® fluorosurfactants, such as CAPSTONE® FS-35, from DuPont, previously known as ZONYL FSO), and combinations thereof. In other examples, the surfactant is an ethoxylated low-foam wetting agent (e.g., SURFYNOL® 440 or SURFYNOL® CT-111 from Air Products and Chemical Inc.) or an ethoxylated wetting agent and molecular defoamer (e.g., SURFYNOL® 420 from Air Products and Chemical Inc.). Still other suitable surfactants include non-ionic wetting agents and molecular defoamers (e.g., SURFYNOL® 104E from Air Products and Chemical Inc.) or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TEGO® Wet 510 (polyether siloxane) available from Evonik). In some examples, it may be desirable to utilize a surfactant having a hydrophilic-lipophilic balance (HLB) less than 10.

Whether a single surfactant is used or a combination of surfactants is used, the total amount of surfactant(s) in the fusing agent 26 may range from about 0.01 wt % to about 10 wt % based on the total weight of the fusing agent 26. In an example, the total amount of surfactant(s) in the fusing agent 26 may be about 3 wt % based on the total weight of the fusing agent 26.

An anti-kogation agent may be included in the fusing agent 26 that is to be jetted using thermal inkjet printing. Kogation refers to the deposit of dried printing liquid (e.g., fusing agent 26) on a heating element of a thermal inkjet printhead. Anti-kogation agent(s) is/are included to assist in preventing the buildup of kogation. Examples of suitable anti-kogation agents include oleth-3-phosphate (e.g., commercially available as CRODAFOS™ O3A or CRODAFOS™ N-3 acid from Croda), or a combination of oleth-3-phosphate and a low molecular weight (e.g., <5,000) polyacrylic acid polymer (e.g., commercially available as CARBOSPERSE™ K-7028 Polyacrylate from Lubrizol).

Whether a single anti-kogation agent is used or a combination of anti-kogation agents is used, the total amount of anti-kogation agent(s) in the fusing agent 26 may range from greater than 0.20 wt % to about 0.65 wt % based on the total weight of the fusing agent 26. In an example, the oleth-3-phosphate is included in an amount ranging from about 0.20 wt % to about 0.60 wt %, and the low molecular weight polyacrylic acid polymer is included in an amount ranging from about 0.005 wt % to about 0.03 wt %.

The FA vehicle may also include antimicrobial agent(s). Suitable antimicrobial agents include biocides and fungicides. Example antimicrobial agents may include the NUOSEPT™ (Troy Corp.), UCARCIDE™ (Dow Chemical Co.), ACTICIDE® B20 (Thor Chemicals), ACTICIDE® M20 (Thor Chemicals), ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof. Examples of suitable biocides include an aqueous solution of 1,2-benzisothiazolin-3-one (e.g., PROXEL® GXL from Arch Chemicals, Inc.), quaternary ammonium compounds (e.g., BARDAC® 2250 and 2280, BARQUAT® 50-65B, and CARBOQUAT® 250-T, all from Lonza Ltd. Corp.), and an aqueous solution of methylisothiazolone (e.g., KORDEK® MLX from Dow Chemical Co.).

In an example, the fusing agent 26 may include a total amount of antimicrobial agents that ranges from about 0.05 wt % to about 1 wt %. In an example, the antimicrobial agent(s) is/are a biocide(s) and is/are present in the fusing agent 26 in an amount of about 0.25 wt % (based on the total weight of the fusing agent 26).

Chelating agents (or sequestering agents) may be included in the FA vehicle to eliminate the deleterious effects of heavy metal impurities. Examples of chelating agents include disodium ethylenediaminetetraacetic acid (EDTA-Na), ethylene diamine tetra acetic acid (EDTA), and methylglycinediacetic acid (e.g., TRILON® M from BASF Corp.).

Whether a single chelating agent is used or a combination of chelating agents is used, the total amount of chelating agent(s) in the fusing agent 26 may range from greater than 0 wt % to about 2 wt % based on the total weight of the fusing agent 26. In an example, the chelating agent(s) is/are present in the fusing agent 26 in an amount of about 0.04 wt % (based on the total weight of the fusing agent 26).

### Detailing Agents

In the examples of the methods 100, 200, 300, 400 and the system 10 disclosed herein, and as mentioned above, a detailing agent 48 may be used. The detailing agent 48 may include a surfactant, a co-solvent, and a balance of water. In some examples, the detailing agent 48 consists of these components, and no other components. In some other examples, the detailing agent 48 may further include a colorant. In still some other examples, detailing agent 48 consists of a colorant, a surfactant, a co-solvent, and a balance of water, with no other components. In yet some other examples, the detailing agent 48 may further include additional components, such as anti-kogation agent(s), antimicrobial agent(s), and/or chelating agent(s) (each of which is described above in reference to the fusing agent 26).

The surfactant(s) that may be used in the detailing agent 48 include any of the surfactants listed above in reference to the fusing agent 26. The total amount of surfactant(s) in the detailing agent 48 may range from about 0.10 wt % to about 5.00 wt % with respect to the total weight of the detailing agent 48.

The co-solvent(s) that may be used in the detailing agent 48 include any of the co-solvents listed above in reference to the fusing agent 26. The total amount of co-solvent(s) in the detailing agent 48 may range from about 1.00 wt % to about 20.00 wt % with respect to the total weight of the detailing agent 48.

Similar to the fusing agent 26, the co-solvent(s) of the detailing agent 48 may depend, in part upon the jetting technology that is to be used to dispense the detailing agent 48. For example, if thermal inkjet printheads are to be used, water and/or ethanol and/or other longer chain alcohols (e.g., pentanol) may make up 35 wt % or more of the detailing agent 48. For another example, if piezoelectric inkjet printheads are to be used, water may make up from about 25 wt % to about 30 wt % of the detailing agent 48, and 35 wt % or more of the detailing agent 48 may be ethanol, isopropanol, acetone, etc.

In some examples, the detailing agent 48 does not include a colorant. In these examples, the detailing agent 48 may be colorless. As mentioned above, “colorless,” means that the detailing agent 48 is achromatic and does not include a colorant.

When the detailing agent 48 includes the colorant, the colorant may be a dye of any color having substantially no absorbance in a range of 650 nm to 2500 nm. By “substantially no absorbance” it is meant that the dye absorbs no radiation having wavelengths in a range of 650 nm to 2500 nm, or that the dye absorbs less than 10% of radiation having wavelengths in a range of 650 nm to 2500 nm. The dye is also capable of absorbing radiation with wavelengths of 650 nm or less. As such, the dye absorbs at least some wavelengths within the visible spectrum, but absorbs little or no wavelengths within the near-infrared spectrum. This is in contrast to the active material in the fusing agent 26, which absorbs wavelengths within the near-infrared spectrum. As such, the colorant in the detailing agent 48 will not substantially absorb the fusing radiation, and thus will not initiate melting and fusing of the build material composition 16 in contact therewith when the build material layer 38 is exposed to the fusing radiation.

The dye selected as the colorant in the detailing agent 48 may also have a high diffusivity (i.e., it may penetrate into greater than 10 μm and up to 100 μm of the build material composition particles 16). The high diffusivity enables the dye to penetrate into the build material composition particles 16 upon which the detailing agent 48 is applied, and also enables the dye to spread into portions of the build material composition 16 that are adjacent to the portions of the build material composition 16 upon which the detailing agent 48 is applied. The dye penetrates deep into the build material composition 16 particles to dye/color the composition particles. When the detailing agent 48 is applied at or just outside the edge boundary 43 (of the final 3D part), the build material composition 16 particles at the edge boundary 43 may be colored. In some examples, at least some of these dyed build material composition 16 particles may be present at the edge(s) or surface(s) of the formed 3D layer or part, which prevents or reduces any patterns (due to the different colors of the fusing agent 26 and the build material composition 16) from forming at the edge(s) or surface(s).

The dye in the detailing agent 48 may be selected so that its color matches the color of the active material in the fusing agent 26. As examples, the dye may be any azo dye having sodium or potassium counter ion(s) or any diazo (i.e., double azo) dye having sodium or potassium counter ion(s), where the color of azo or dye azo dye matches the color of the fusing agent 26.

In an example, the dye is a black dye. Some examples of the black dye include azo dyes having sodium or potassium counter ion(s) and diazo (i.e., double azo) dyes having sodium or potassium counter ion(s). Examples of azo and diazo dyes may include tetrasodium (6Z)-4-acetamido-5-oxo-6-[[7-sulfonato-4-(4-sulfonatophenyl)azo-1-naphthyl]hydrazono]naphthalene-1,7-disulfonate with a chemical structure of:

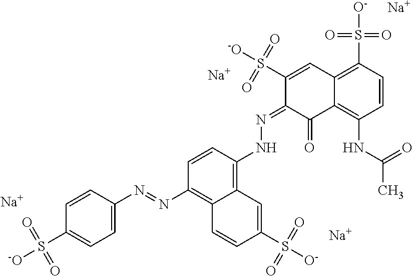

(commercially available as Food Black 1); tetrasodium 6-amino-4-hydroxy-3-[[7-sulfonato-4-[(4-sulfonatophenyl)azo]-1-naphthyl]azo]naphthalene-2,7-disulfonate with a chemical structure of:

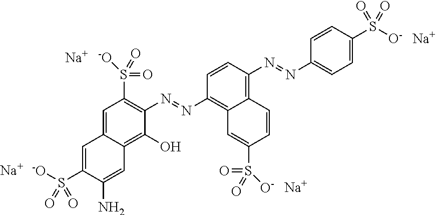

(commercially available as Food Black 2); tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

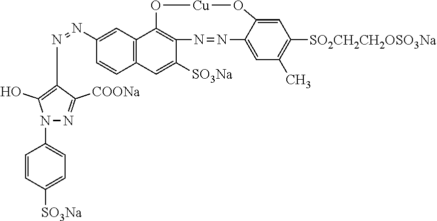

(commercially available as Reactive Black 31); tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

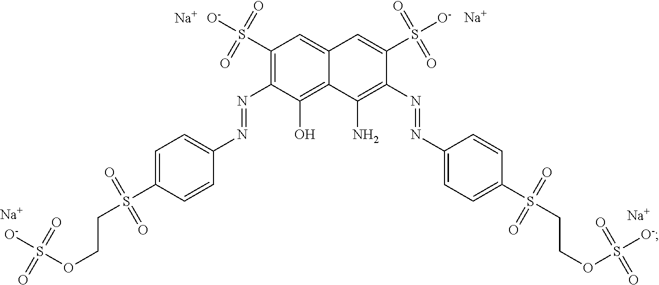

and combinations thereof. Some other commercially available examples of the dye used in the detailing agent 48 include multipurpose black azo-dye based liquids, such as PRO-JET® Fast Black 1 (made available by Fujifilm Holdings), and black azo-dye based liquids with enhanced water fastness, such as PRO-JET® Fast Black 2 (made available by Fujifilm Holdings).

In some instances, in addition to the black dye, the colorant in the detailing agent 48 may further include another dye. In an example, the other dye may be a cyan dye that is used in combination with any of the dyes disclosed herein. The other dye may also have substantially no absorbance above 650 nm. The other dye may be any colored dye that contributes to improving the hue and color uniformity of the final 3D part.

Some examples of the other dye include a salt, such as a sodium salt, an ammonium salt, or a potassium salt. Some specific examples include ethyl-[4-[[4-[ethyl-[(3-sulfophenyl) methyl] amino] phenyl]-(2-sulfophenyl) ethylidene]-1-cyclohexa-2,5-dienylidene]-[(3-sulfophenyl) methyl] azanium with a chemical structure of:

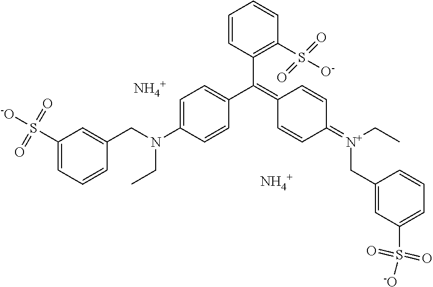

(commercially available as Acid Blue 9, where the counter ion may alternatively be sodium counter ions or potassium counter ions); sodium 4-[(E)-{4-[benzyl(ethyl)amino]phenyl}{(4E)-4-[benzyl(ethyl)iminio]cyclohexa-2,5-dien-1-ylidene}methyl]benzene-1,3-disulfonate with a chemical structure of:

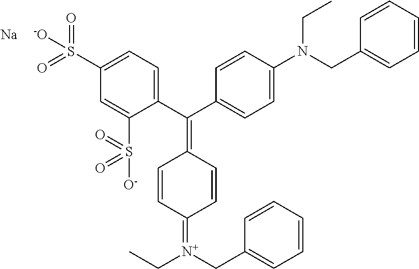

(commercially available as Acid Blue 7); and a phthalocyanine with a chemical structure of:

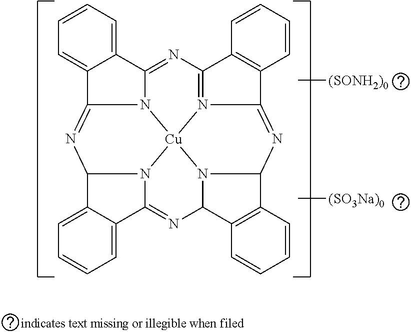

(commercially available as Direct Blue 199); and combinations thereof.

In an example of the detailing agent 48, the dye may be present in an amount ranging from about 1.00 wt % to about 3.00 wt % based on the total weight of the detailing agent 48. In another example of the detailing agent 48 including a combination of dyes, one dye (e.g., the black dye) is present in an amount ranging from about 1.50 wt % to about 1.75 wt % based on the total weight of the detailing agent 48, and the other dye (e.g., the cyan dye) is present in an amount ranging from about 0.25 wt % to about 0.50 wt % based on the total weight of the detailing agent 48.

The balance of the detailing agent 48 is water. As such, the amount of water may vary depending upon the amounts of the other components that are included.

### Coloring Agents

In the examples of the methods 100, 200, 300, 400 and the system 10 disclosed herein, and as mentioned above, a coloring agent 50 may be used. The coloring agent 50 may include a colorant, a surfactant, a co-solvent, and a balance of water. In some examples, the coloring agent 50 consists of these components, and no other components. In some other examples, the coloring agent 50 may further include additional components, such as dispersant(s), anti-kogation agent(s), antimicrobial agent(s), and/or chelating agent(s) (each of which is described above in reference to the fusing agent 26).

The coloring agent 50 may be a black ink, a cyan ink, a magenta ink, or a yellow ink. As such, the colorant may be a black colorant, a cyan colorant, a magenta colorant, a yellow colorant, or a combination of colorants that together achieve a black, cyan, magenta, or yellow color.

In an example, the colorant may be present in the coloring agent 50 in an amount ranging from about 0.1 wt % to about 10 wt % (based on the total weight of the coloring agent 50). In another example, the colorant may be present in the coloring agent 50 in an amount ranging from about 0.5 wt % to about 5 wt % (based on the total weight of the coloring agent 50). In still another example, the colorant may be present in the coloring agent 50 in an amount ranging from about 2 wt % to about 10 wt % (based on the total weight of the coloring agent 50).

In some examples, the colorant may be a dye. The dye may be non-ionic, cationic, anionic, or a combination thereof. Examples of dyes that may be used include Sulforhodamine B, Acid Blue 113, Acid Blue 29, Acid Red 4, Rose Bengal, Acid Yellow 17, Acid Yellow 29, Acid Yellow 42, Acridine Yellow G, Acid Yellow 23, Acid Blue 9, Nitro Blue Tetrazolium Chloride Monohydrate or Nitro BT, Rhodamine 6G, Rhodamine 123, Rhodamine B, Rhodamine B Isocyanate, Safranine O, Azure B, and Azure B Eosinate, which are available from Sigma-Aldrich Chemical Company (St. Louis, Mo.). Examples of anionic, water-soluble dyes include Direct Yellow 132, Direct Blue 199, Magenta 377 (available from Ilford AG, Switzerland), alone or together with Acid Red 52. Examples of water-insoluble dyes include azo, xanthene, methine, polymethine, and anthraquinone dyes. Specific examples of water-insoluble dyes include Orasol® Blue GN, Orasol® Pink, and Orasol® Yellow dyes available from Ciba-Geigy Corp. Black dyes may include Direct Black 154, Direct Black 168, Fast Black 2, Direct Black 171, Direct Black 19, Acid Black 1, Acid Black 191, Mobay Black SP, and Acid Black 2. The dye may also be any of the examples listed in reference to the detailing agent 48.

In other examples, the colorant may be a pigment. As used herein, “pigment” may generally include organic and/or inorganic pigment colorants that introduce color to the coloring agent 50 and the 3D printed part. The pigment can be self-dispersed with a polymer, oligomer, or small molecule or can be dispersed with a separate dispersant (described above in reference to the fusing agent 26).

Examples of pigments that may be used include Paliogen® Orange, Heliogen® Blue L 6901F, Heliogen® Blue NBD 7010, Heliogen® Blue K 7090, Heliogen® Blue L 7101F, Paliogen® Blue L 6470, Heliogen® Green K 8683, and Heliogen® Green L 9140 (available from BASF Corp.). Examples of black pigments include Monarch® 1400, Monarch® 1300, Monarch® 1100, Monarch® 1000, Monarch® 900, Monarch® 880, Monarch® 800, and Monarch® 700 (available from Cabot Corp.). Other examples of pigments include Chromophtal® Yellow 3G, Chromophtal® Yellow GR, Chromophtal® Yellow 8G, Igrazin® Yellow 5GT, Igralite® Rubine 4BL, Monastral® Magenta, Monastral® Scarlet, Monastral® Violet R, Monastral® Red B, and Monastral® Violet Maroon B (available from CIBA). Still other examples of pigments include Printex® U, Printex® V, Printex® 140U, Printex® 140V, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4 (available from Evonik). Yet other examples of pigments include Tipure® R-101 (available from DuPont), Dalamar® Yellow YT-858-D and Heucophthal Blue G XBT-583D (available from Heubach). Yet other examples of pigments include Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, Novoperm® Yellow HR, Novoperm® Yellow FGL, Hansa Brilliant Yellow 10GX, Permanent Yellow G3R-01, Hostaperm® Yellow H4G, Hostaperm® Yellow H3G, Hostaperm® Orange GR, Hostaperm® Scarlet GO, and Permanent Rubine F6B (available from Clariant). Yet other examples of pigments include Quindo® Magenta, Indofast® Brilliant Scarlet, Quindo® Red R6700, Quindo® Red R6713, and Indofast® Violet (available from Mobay). Yet other examples of pigments include L74-1357 Yellow, L75-1331 Yellow, and L75-2577 Yellow, LHD9303 Black (available from Sun Chemical). Yet other examples of pigments include Raven® 7000, Raven® 5750, Raven® 5250, Raven® 5000, and Raven® 3500 (available from Columbian).

When the coloring agent 50 is applied at or just outside the edge boundary 43 (of the final 3D part), the build material composition 16 at the edge boundary 43 may be colored. In some examples, at least some of these dyed build material composition 16 particles may be present at the edge(s) or surface(s) of the formed 3D layer or part, which prevents or reduces any patterns (due to the different colors of the fusing agent 26 and the build material composition 16) from forming at the edge(s) or surface(s).

The surfactant(s) that may be used in the coloring agent 50 include any of the surfactants listed above in reference to the fusing agent 26. The total amount of surfactant(s) in the coloring agent 50 may range from about 0.01 wt % to about 20 wt % with respect to the total weight of the coloring agent 50. In an example, the total amount of surfactant(s) in the coloring agent 50 may range from about 5 wt % to about 20 wt % with respect to the total weight of the coloring agent 50.

The co-solvent(s) that may be used in the coloring agent 50 include any of the co-solvents listed above in reference to the fusing agent 26. The total amount of co-solvent(s) in the coloring agent 50 may range from about 1 wt % to about 50 wt % with respect to the total weight of the coloring agent 50.

Similar to the fusing agent 26 and detailing agent 48, the co-solvent(s) of the coloring agent 50 may depend, in part upon the jetting technology that is to be used to dispense the coloring agent 50. For example, if thermal inkjet printheads are to be used, water and/or ethanol and/or other longer chain alcohols (e.g., pentanol) may make up 35 wt % or more of the coloring agent 50. For another example, if piezoelectric inkjet printheads are to be used, water may make up from about 25 wt % to about 30 wt % of the coloring agent 50, and 35 wt % or more of the coloring agent 50 may be ethanol, isopropanol, acetone, etc.

The balance of the coloring agent 50 is water. As such, the amount of water may vary depending upon the amounts of the other components that are included.

To further illustrate the present disclosure, an example is given herein. It is to be understood this example is provided for illustrative purposes and is not to be construed as limiting the scope of the present disclosure.

### EXAMPLE

An example of the build material composition disclosed herein was tested to determine its suitability for being reused/recycled. The example build material composition included, as the glass core, soda lime glass beads (SPHERIGLASS® A-Glass 3000 Solid Glass Microspheres from Potters Industries, LLC) that were not modified with any functional group. The example build material composition further included, as the polyamide material coated on the glass core, a polyamide 12 with a starting solution viscosity (i.e., the solution viscosity before any aging process) of about 1.73 and a reactivity of about 5%.

The example build material composition was aged at 165° C. for 20 hours in an air environment. The melt flow index of the example build material composition was determined both before and after it was aged. The melt flow index of the fresh example build material composition (i.e., before the aging process) was about 46.1, and the melt flow index of the aged example build material composition (i.e., after the aging process) was about 25.5. The change in the melt flow index was about −45% ((25.5-46.1)/46.1−100%). The change in the melt flow index indicates that the example build material composition is suitable for being reused/recycled at a weight ratio of recycled build material to fresh build material of 30:70 (although a weight ratio including a greater amount of fresh build material may be used).

It is to be understood that the ranges provided herein include the stated range and any value or sub-range within the stated range. For example, from about 165° C. to about 177° C. should be interpreted to include not only the explicitly recited limits of from about 165° C. to about 177° C., but also to include individual values, such as about 165.5° C., about 167.74° C., about 174° C., about 175° C., etc., and sub-ranges, such as from about 166° C. to about 175° C., from about 160.5° C. to about 160.75° C., from about 171° C. to about 176.75° C., etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A method for three-dimensional (3D) printing, comprising:
applying a build material composition to form a build material layer, the build material composition including a glass core coated with a polyamide material;
based on a 3D object model, selectively applying a fusing agent on a portion of the build material composition;
based on the 3D object model, selectively applying a detailing agent on an other portion of the build material composition; and
exposing the build material composition to radiation to fuse the portion to form a layer of a 3D part.

2. The method as defined in claim 1 wherein the glass core is selected from the group consisting of soda lime glass, borosilicate glass, phosphate glass, fused quartz, and a combination thereof.

3. The method as defined in claim 1 wherein a surface of the glass core is modified with a functional group selected from the group consisting of an acrylate functional silane, a methacrylate functional silane, an epoxy functional silane, an ester functional silane, an amino functional silane, and a combination thereof.

4. The method as defined in claim 1 wherein the glass core is selected from the group consisting of solid glass beads, hollow glass beads, porous glass beads, glass fibers, crushed glass, and a combination thereof.

5. The method as defined in claim 1 wherein the polyamide material is selected from the group consisting of polyamide 12, polyamide 11, polyamide 6, polyamide 13, and a combination thereof.

6. The method as defined in claim 1 wherein the build material composition further includes a filler selected from the group consisting of alumina, silica, glass, talc, and a combination thereof.

7. The method as defined in claim 1, further comprising selectively applying, based on the 3D object model, the detailing agent on at least some of the portion of the build material composition.

8. The method as defined in claim 1, further comprising selectively applying, based on the 3D object model, a coloring agent on at least some of the portion of the build material composition, the coloring agent being selected from the group consisting of a black ink, a cyan ink, a magenta ink, and a yellow ink.

9. The method as defined in claim 1, further comprising:
repeating the applying of the build material composition, the selectively applying of the fusing agent, the selectively applying of the detailing agent, and the exposing of the build material composition, wherein the repeating forms the 3D part including the layer; and
heating the 3D part at a temperature ranging from greater than 30° C. to about 177° C. for a time period ranging from greater than 0 hours to about 144 hours.

10. A method for three-dimensional (3D) printing, comprising:
applying a build material composition to form a build material layer, the build material composition including a glass core coated with a polyamide material, wherein a surface of the glass core is modified with a functional group selected from the group consisting of an acrylate functional silane, a methacrylate functional silane, an epoxy functional silane, an ester functional silane, an amino functional silane, and a combination thereof;
based on a 3D object model, selectively applying a fusing agent on at least a portion of the build material composition; and
exposing the build material composition to radiation to fuse the at least the portion to form a layer of a 3D part.

11. The method as defined in claim 10, further comprising selectively applying, based on the 3D object model, a detailing agent on at least some of the at least the portion of the build material composition.

12. The method as defined in claim 10, further comprising selectively applying, based on the 3D object model, a coloring agent on at least some of the at least the portion of the build material composition, the coloring agent being selected from the group consisting of a black ink, a cyan ink, a magenta ink, and a yellow ink.

13. A method for three-dimensional (3D) printing, comprising:
applying a build material composition to form a build material layer, the build material composition including a glass core coated with a polyamide material, the polyamide material being selected from the group consisting of polyamide 11, polyamide 6, polyamide 13, and a combination thereof;
based on a 3D object model, selectively applying a fusing agent on at least a portion of the build material composition; and
exposing the build material composition to radiation to fuse the at least the portion to form a layer of a 3D part.

14. The method as defined in claim 13, further comprising selectively applying, based on the 3D object model, a detailing agent on at least some of the at least the portion of the build material composition.

15. The method as defined in claim 13, further comprising selectively applying, based on the 3D object model, a coloring agent on at least some of the at least the portion of the build material composition, the coloring agent being selected from the group consisting of a black ink, a cyan ink, a magenta ink, and a yellow ink.
